(19) United States
(12) Patent Application Publication
(10) Pub. No.: US 2008/0086413 A1
(43) Pub. Date: Apr. 10, 2008

(54) SYSTEMS AND METHODS FOR COLLABORATIVE PAYMENT STRATEGIES

(76) Inventors: Stephen L. Malloy, San Francsico, CA (US); Alan J. Walters, Chicago, IL (US)

Correspondence Address: MCANDREWS HELD & MALLOY, LTD, 500 WEST MADISON STREET, SUITE 3400, CHICAGO, IL, 60661, US

(21) Appl. No.: 11/870,202

(22) Filed: Oct. 10, 2007

Related U.S. Application Data
(60) Provisional application No. 60/850,490, filed on Oct. 10, 2006.

(51) Int. Cl. G06Q 40/00

(52) U.S. Cl. 705/39

(57) ABSTRACT

Certain embodiments of the present invention provide systems and methods for collaborative payment strategies. Buyers, sellers, and financial institutions may utilize a collaborative payment application to facilitate collaboration and share best practices for processing payments and deductions as part of a collaborative payment system. In certain embodiments, the collaborative payment system acts as repository for buyer compliance guideline information. The collaborative payment system facilitates transactions between buyers, sellers, and financial institutions using best practices derived from shared knowledge of each participant's capabilities and practices.

### RELATED APPLICATIONS

This application is related to, and claims the benefit of, Provisional Application No. 60/850,490, filed on Oct. 10, 2006, and entitled “Collaborative Systems and Methods for Analysis and Comparison of Financial Transactions,” which is herein incorporated by reference in its entirety.

### BACKGROUND OF THE INVENTION

The presently described technology generally relates to payment processing. More particularly, the presently described technology relates to systems and methods for collaborative payment strategies.

FIG. 1 illustrates a typical transaction 100 for the purchase of goods. As shown in FIG. 1, the transaction involves a buyer 110, a seller 130, and a financial institution 120. Typically, the buyer 110 sends a purchase request 102 or purchase order to the seller 130. The purchase request 102 identifies the goods the buyer 110 desires. The seller 130 receives the buyer's purchase request and then ships the goods to the buyer 110.

Along with or separate from the goods, the seller 130 may send a statement or invoice 105. While the term “invoice” is used herein, it is understood that this data may take the form of a statement. The invoice 105 typically lists the goods being shipped and may include other information such as price, quantity, a seller coding or identification such as a SKU number and/or other order information. Alternatively, instead of a single invoice for a single shipment, a statement reflecting multiple shipments may be employed in situations where multiple shipments are sent to the same buyer.

Once the buyer 110 has received the seller's goods and invoice 105, the buyer 110 pays for the goods at that time or at some time thereafter. Presently, in many cases, buyers pay for goods using any of a variety of methods including cash, checks, credit cards, Automated Clearing House (ACH) or other electronic/wire transfer. Regardless of the method of payment, the buyer's payment and/or information is remitted to the financial institution 120 as remittance information 115. In some cases, the payment and/or information is sent initially to the seller 130, who then passes it along to the financial institution 120.

The financial institution 120 receives the buyer's payment and remittance 115 and deposits the funds in seller's account at the financial institution 120. The financial institution 120 then alerts the seller 130 that a payment has been received by sending payment data 125 to the seller 130.

The payment data 125 may take the form of a monthly, weekly, or typically a daily account summary. In the most preferable configuration, the account summary is updated several times a day. The payment data may also be electronically sent to the seller 130 or may be provided to the seller 130 by allowing the seller to electronically access the financial institution's records or photocopies may be mailed to the seller 130.

Additionally, as mentioned above, the buyer's payment may be received in any of a variety of methods. However, regardless of the type of payment received, the payment is typically converted to an electronic expression by the financial institution 120. For example, a paper check that is received by the financial institution 120 may be scanned or imaged and the payment data on the face of the check may be converted into an electronic expression by a data entry person at the financial institution 120. ACH or wire transfers are already in an electronic form, but the financial institution's record of the transaction may also reflect the originator of the ACH and the date of the ACH, for example. Typically, most of the bank's electronic data is sent to the seller 130 as the payment data 125.

Once the payment data 125 has been received by the seller 130, the seller 130 must then begin the laborious task of matching each received payment with the corresponding invoice. That is, in order to confirm that the buyer 110 has paid for the goods that were shipped, the seller 130 matches the payment data 125 received from the financial institution 120 to the invoice data 105 that was sent to the buyer 110. Once the seller 130 has matched the invoice data 105 to the payment data 125, the transaction is said to be closed-out, provided that the invoice data matches the payment data exactly. For a seller 130 with a large number of invoices, this process may be very time consuming.

Some current systems support electronic payment processing including electronic receipt of funds and/or remittance information from a buyer 110. Additionally, some current systems support electronic payment processing including electronic receipt of invoices or bills of lading from sellers 130. The received information may be used in a system that first attempts to automatically match all received payments with invoices, such the system further described in U.S. patent application Ser. No. 10/866,015 filed Jun. 10, 2004, entitled “System and Method for Automated Incoming Payment and Invoice Reconciliation.” The received invoices that are not able to be directly matched by the invoice reconciliation system may then be referred to the automated payment processing and exception management system described further in U.S. patent application Ser. No. 10/865,076 filed Jun. 10, 2004, entitled “System And Method For Automated Payment And Adjustment Processing.”

As discussed above, the invoice 105 may list information about the goods being sold to the buyer 110 by the seller 130. As might be expected, each buyer 110 may have different requirements for the format of invoice 105 information. However, a buyer 110 may purchase goods from many sellers 130 and the sellers may have their own requirements. For example, a large retailer may purchase goods from a number of different suppliers to be sold in the retailer's stores.

For the convenience and efficiency of the buyer 110, the buyer 110 may require that sellers 130 comply with various guidelines in conducting transactions with the buyer 110. These guidelines are typically laid out in a vendor compliance guide from the buyer 110.

The buyer's compliance guideline information may specify information such as codes for products, codes for compliance rules which may be referenced on remittance information or debit memos, minimum non-compliance fees for a specified violation, additional fees for multiple instances of a single code violation, maximum fees per code violation, penalty fees for repeat instances of the same violation, points of contact at the buyer's organization to manage account inquiries, merchandise shipping guidelines, carrier selection guidelines, labeling requirements for products and packaging, and EDI compliance requirements, for example. Discrepancies or non-compliance with a buyer's guidelines may result in delays in payment to the seller 130 and/or financial penalties or adjustments by the buyer 110. Reason codes for short-payments may be specified in the guideline information indicating why a buyer did not pay in full because a seller did not correctly comply with the guidelines, for example.

For a seller 130 dealing with multiple buyers 110, where each buyer 110 has its own guidelines, the seller 130 faces significant overhead in determining why a particular buyer made a short-payment because the seller 130 violated that buyer's 110 guidelines, for example. Each buyer 110 is likely to have its own specific codes in its guidelines. Thus, a seller 130 must typically manually track down the guidelines for that buyer 110 and evaluate the reason code given by the buyer 110. As a seller deals with an increasing number of buyers, where each buyer has different guidelines, the amount of information the seller 130 must deal with increases, along with the complexity of dealing with the information.

In addition, a buyer 110, even if so inclined, cannot easily support a seller's compliance with the buyer's guidelines. For example, each seller 130 may have its own internal codes which may not match the buyer's codes. Thus, it would be difficult for a buyer 110 to provide a standard conversion as each seller 130 would have different codes, necessitating the buyer 110 to provide conversions for every seller 130 the buyer 110 deals with. Also, buyers 110 typically prefer not to bear the burden of providing conversions to a particular buyer's 110 codes for all potential sellers 130.

Thus, in light of the shortcomings of the prior art outlined above, a more streamlined and less costly method for using codes has long been desired.

### BRIEF SUMMARY OF THE INVENTION

Certain embodiments of the present invention provide systems and methods for collaborative payment strategies. Buyers, sellers, and financial institutions may utilize a collaborative payment application to facilitate collaboration and share best practices for processing payments and deductions as part of a collaborative payment system. When new buyers and sellers sign up to participate in the collaborative payment system, they can take advantage of an existing store of knowledge for handling transactions with other participants. In addition, advantageous practices the new buyers and sellers bring to the collaborative payment system are shared to be utilized by other participants.

In certain embodiments, the collaborative payment system acts as repository for buyer compliance guideline information. The collaborative payment system allows sellers to have access to a single storehouse of the compliance guidelines. In addition, the collaborative payment system allows for automatic mapping of codes between buyers and sellers. In this way, the collaborative payment system facilitates transactions between buyers, sellers, and financial institutions using best practices derived from shared knowledge of each participant's capabilities and practices.

### BRIEF DESCRIPTION OF SEVERAL VIEWS OF THE DRAWINGS

FIG. 1 illustrates a typical transaction for the purchase of goods.

FIG. 2 illustrates a collaborative payment system according to an embodiment of the present invention.

FIG. 3 illustrates a flow chart of the loading of seller information into the collaborative payment application according to an embodiment of the present invention.

FIG. 4 illustrates a flow chart of the comparison of seller information in the collaborative payment application according to an embodiment of the present invention.

FIG. 5 illustrates a flow chart of the maintenance of seller information in the collaborative payment application according to an embodiment of the present invention.

FIG. 6 illustrates a flow chart of the notification of sellers by the collaborative payment application according to an embodiment of the present invention.

FIG. 7 illustrates a flow chart of the maintenance of capabilities of a financial institution in the collaborative payment application according to an embodiment of the present invention.

FIG. 8 illustrates a flow chart of the notification of sellers by the collaborative payment application according to an embodiment of the present invention.

FIG. 9 illustrates a flow chart of the notification of buyers by the collaborative payment application according to an embodiment of the present invention.

FIG. 10 illustrates a flow chart of the optimization of seller payment/remittance processing by the collaborative payment application according to an embodiment of the present invention.

FIG. 11 illustrates a flow chart of the operation of the collaborative payment application according to an embodiment of the present invention.

FIG. 12 illustrates a flow chart of the generation of business rules by the collaborative payment application according to an embodiment of the present invention.

FIG. 13 illustrates a collaborative payment application according to an embodiment of the present invention.

FIG. 14 illustrates an exemplary ranking table according to an embodiment of the present invention.

FIG. 15 illustrates another exemplary ranking table according to an embodiment of the present invention.

FIG. 16 illustrates a user interface for the collaborative payment application showing buyer capabilities according to an embodiment of the present invention.

FIG. 17 illustrates a user interface for the collaborative payment application showing the current configurations for buyers associated with a particular seller according to an embodiment of the present invention.

FIG. 18 illustrates a collaborative payment system in which the collaborative payment application is distributed hierarchically according to an embodiment of the present invention.

FIG. 19 illustrates an embodiment of an adjustment processing application.

FIG. 20 illustrates an exemplary operation of the workflow approval processor in accordance with a pre-configured, buyer-specific adjustment approval workflow.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

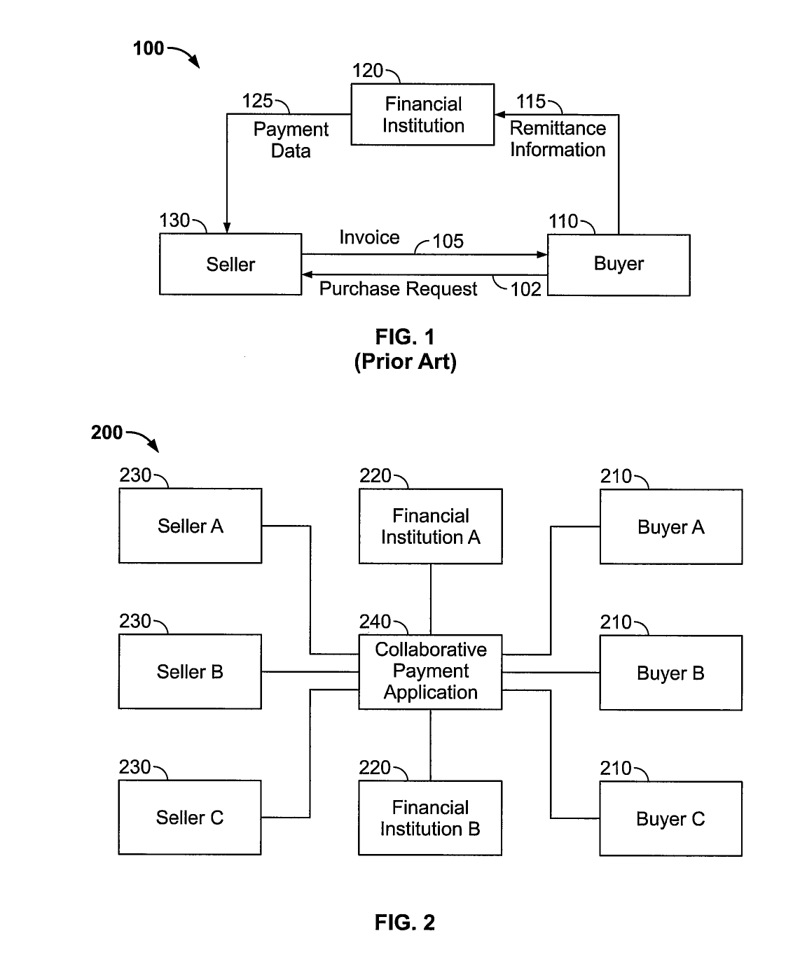

FIG. 2 illustrates a collaborative payment system 200 according to an embodiment of the present invention. The collaborative payment system 200 includes buyers 210, financial institutions 220, sellers 230, and a collaborative payment application 240.

The collaborative payment application 240 is in communication with the buyers 210, financial institutions 220, and the sellers 230.

In operation, as further described below, the collaborative payment application 240 provides, coordinates, and/or manages payment strategies for participating buyers 210, financial institutions 220, and sellers 230 in the collaborative payment system 200. The payment strategies preferably represent the “best practices” for transactions involving the buyers 210, the financial institutions 220, and the sellers 230. A “best practice” may include the most-automated and/or electronic configuration for submitting a payment instruction and its corresponding remittance detail information (with or without adjustment codes), for example. For example, a check along with a hand-written, faxed copy of a remittance may be less desirable than an electronic payment request plus complete electronic remittance. The electronic data may not need to be scanned or re-keyed, resulting in reduced expense and eliminating a potential source of data entry error. The payment and remittance data may then be transmitted as originally supplied to a bank from a buyer for further review by the seller.

The payment strategies may be based on practices a new buyer 210 or seller 230 brings to the collaborative payment system 200. For example, “Buyer B” may be a new participant in the collaborative payment system 200. Buyer B may have had previously existing relationships with Seller A using a completely paper-based interaction. When Buyer B joins the collaborative payment system 200, Buyer B may be notified that Seller A supports electronic payment and Seller A's financial institution 220 supports electronic remittance. Buyer B may then switch to using these electronic capabilities for more efficient transactions with Seller A. As another example, “Seller C” may be a new participant in the collaborative payment system 200. Seller C may have knowledge of Buyer A's processing capabilities which may be used to improve processing efficiency for other sellers 230 who adopt this knowledge. For example, Seller C may know that Buyer A has added EDI 820 remittance functionality to provide very detailed remittance advice information. By updating this information from Seller C in the collaborative payment system 200, other participating sellers 230 may be notified of this capability of Buyer A and thus improve the efficiency of their transactions with Buyer A.

The payment strategies may be based on new capabilities of a financial institution 220, a particular seller 230, and/or a particular buyer 210. For example, when a financial institution 220 is upgraded to process a new type of electronic remittance or payment, sellers 230 and buyers 210 may be notified to take advantage of the new capability. As another example, Financial Institution A may add the capability to transmit data via CTX (Corporate Trade Exchange) formatting which enables payment via ACH transaction. This process upgrade may eliminate manually re-keying payment data, potentially saving time and resources. As another example, Financial Institution B may add the ability to receive EDI 820 remittance information along with a wire payment so that a seller 230 using an advanced cash application system may automatically re-associate a payment with the intended invoices.

Thus, sellers 230 in the collaborative payment system 200 each directly benefit from the best practices for dealing with a particular buyer 210. Buyers 210 indirectly benefit by having sellers 230 (their vendors) better able to process remittance directives. For example, if remittance data is more complete and delivered in a more automated fashion (such as electronically), sellers 230 may be less likely to contact buyers 210 with questions about deductions taken or penalties levied. In addition, sellers 230 may be better positioned to evaluate on-going causes of penalties due to better information and may be incentivized to fix problems which add processing expense to the buyers 210. For example, if a seller 230 routinely delivers a product late to a buyer 210, the buyer 210 charges a penalty to the seller 230 as indicated in the buyer's compliance guideline information. The penalties may help to offset the expense and difficulty of processing late shipments, for example. If the seller 230 remedies the transportation problems, the buyer 230 benefits from on-time shipments and the seller 230 benefits from not having penalties assessed.

The collaborative payment application 240 may also act as repository for buyer compliance guideline information. Thus, sellers 230 and financial institutions 220 have access to the compliance guidelines for each buyer 210 for use in processing transactions. Access to these compliance guidelines permits sellers 230 to proactively employ procedures that comply, avoiding non-compliance penalties.

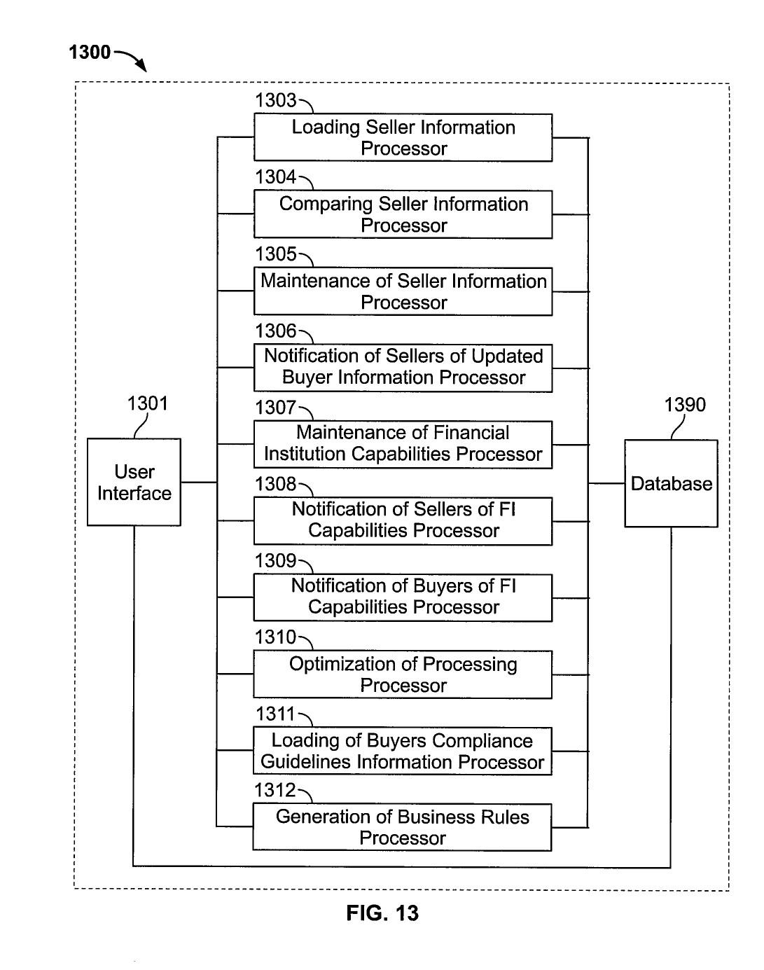

The collaborative payment system 200 utilizes the collaborative payment application 240 to provide the various features described above. The collaborative payment application 240 supports various operations and processes for the collaborative payment system 200. This support is provided, in part, through database and user interface components of the collaborative payment application 240. An exemplary embodiment of a collaborative payment application 240 is discussed in more detail below with respect to FIG. 13.

The collaborative payment application 240 may be implemented, for example, as a package software application or installed at a financial institution or other third party such as an application service provider (ASP). As an ASP, the collaborative payment application 240 may be directly hosted by the financial institution 220, the seller 230 or a third party. The actual physical location of the collaborative payment application 240 is not limited as long as it remains in communication with the financial institution 220, the buyers 210, and the sellers 230. For example, the collaborative payment application 240 may be hosted or installed at the financial institution 220, installed at a third party or may be otherwise outsourced to a third party.

Various use cases of the collaborative payment system 200 are described in more detail below.

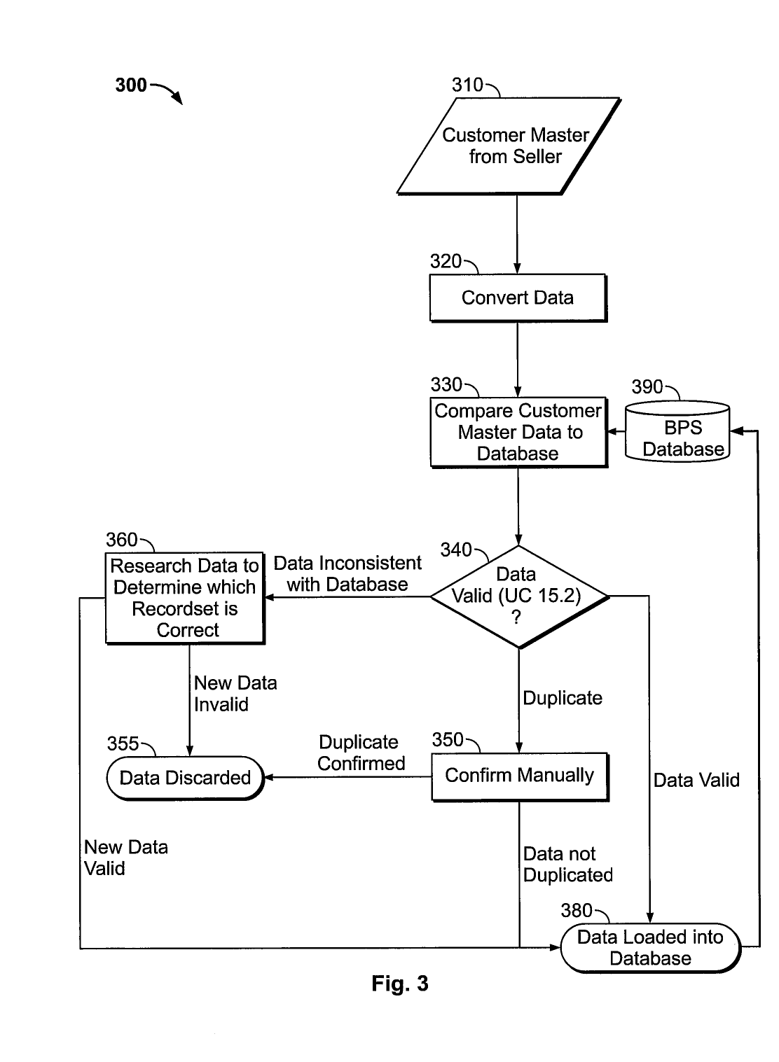

FIG. 3 illustrates a flow chart 300 of the loading of seller information into the collaborative payment application 240 according to an embodiment of the present invention. More particularly, the flow chart 300 illustrates the loading of seller information into the database 390. This operation may occur when a new seller signs up for the collaborative payment system 200, for example. The new seller may be similar to the seller 230, described above, for example.

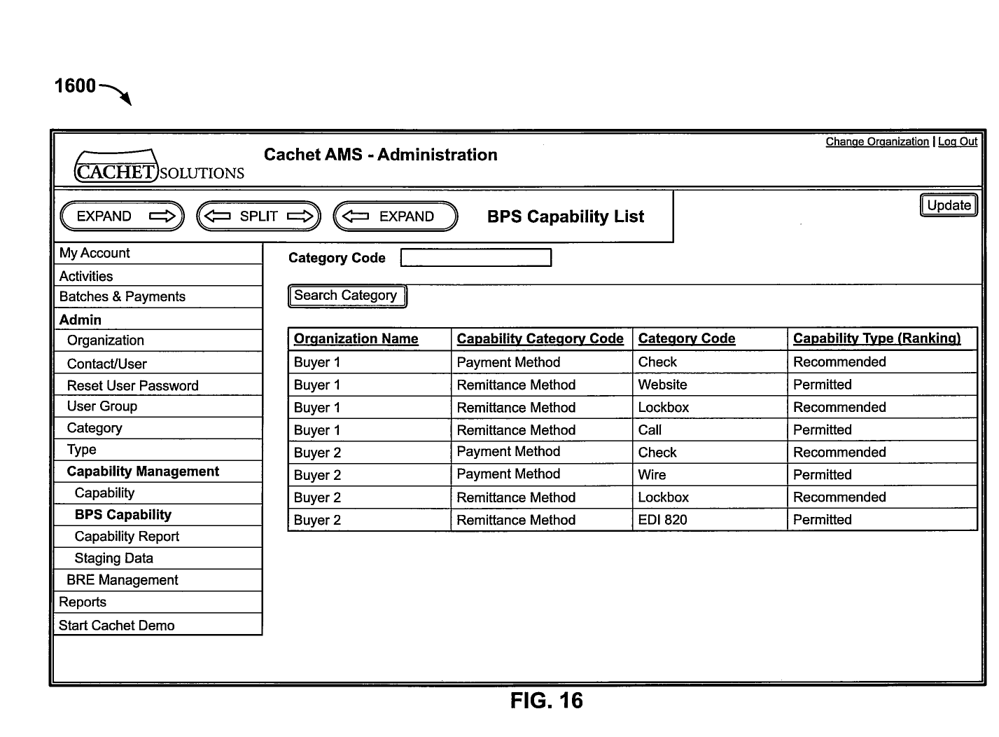

The seller information may include, for example, capabilities of the seller 230 to receive payments, remittance codes or debit memos from the financial institution 220. The seller information may also include, for example, information about buyers 210 the seller 230 deals with, such as ID codes, contact information, payment capabilities, invoicing capabilities, remittance capabilities, cash application configuration, adjustment codes, and templates for adjustment workflow routing. The seller information, or “customer master data,” may include information the seller has regarding one or more buyers that the seller deals with, for example. The seller information may include identification and contact information for the buyers, for example. The seller information may come from a seller's Enterprise Resource Planning application (ERP), for example. The customer master data may include elements such as buyer identification information including name, address, and stock ticker symbol; payment preferences and alternate payment preferences, technical payment capabilities such as whether the buyer is CTX enabled, communication protocols supported such as VAN and AS2, and EDI capabilities for 812 for credit adjustment or 820 to support Electronic Funds Transfer. In addition, the master data can be populated with financial performance data such as revenue, operating margins, and/or credit ratings from internal sources or external providers such as Hoover's Database. FIG. 16 illustrates a user interface 1600 for the collaborative payment application 240 showing buyer capabilities according to an embodiment of the present invention. The user interface 1600 displays capability categories and values such as codes and rankings, for entries for buyers 210 in the database 390. The user interface 1600 includes entries for “Organization Name”, “Capability Category Code”, “Category Code”, and “Capability Type (Ranking)”. The following table describes a list of fields for a buyer 210 in the database 390 according to an embodiment of the present invention.

| Field | Description |
|---|---|
| Company | Buyer Name |
| Homepage | Website address |
| Rev ($MM) | Revenue amount |
| Market Segment | NAICS or SIC or other classification |
| Vendor Manual/Notes | Copy of the manual and or notes about how the |
| | buyer conducts business and best practices |
| | handling thereof |
| Additional Web | Other web address or instructions of how to |
| Information | logon to vendor site |
| Additional Info II | Other web address or instructions of how to |
| | logon to vendor site |
| Additional Web | Other web address or instructions of how to |
| Information II | logon to vendor site |
| Ticker Symbol | Stock Ticker |
| Company ID | Internal ID |
| Payment Preferences I | How the buyer prefers to pay most |
| Payment Preferences II | How the buyer prefers to pay 2nd most |
| Payment Capabilites | How the buyer is capable of paying |
| Remittance Preferences | How the buyer prefers to pay most |
| I | |
| Remittance Preferences | How the buyer prefers to pay 2nd most |
| II | |
| Remittance Capabilites | How the buyer is capable of paying |
| VAN Communication | Information about Buyer's VAN processing |
| Method | capabilities |
| AS2 Communication | Information about Buyer's AS2 processing |
| Method | capabilities |
| EDI 812 | Information about Buyer's Deduction |
| | Processing processing capabilities |
| EDI 820 | Information about Buyer's Remittance |
| | Processing processing capabilities |
| EDI Contact(s) | Contact information for EDI processing agent |
| Non-Compliance Fee | The buyer's deduction codes and fees |
| Schedule | charged for noncompliance |

Typically, before the operation illustrated in the flow chart 300 occurs, the database 390 is populated with data. For example, the database 390 may include data from various participating sellers 230. The new seller 230 whose information is to be loaded typically will have signed up for the collaborative payment processing service provided by the collaborative payment system 200. In addition, typically the new seller 230 and/or the financial institution 220 will supply the seller information.

The data may be batch loaded in the database 390. That is, a set of data for one or more sellers 230 may be loaded at one time in an automatic manner. Alternatively, the data may be loaded by a system administrator. The system administrator may load the data individually, for example.

After the operation illustrated in the flow chart 300, which is described in more detail below, occurs, the seller information is loaded and deduped. That is, duplicate information has been removed.

Turning to the flowchart 300, first, customer master data is received from the seller 230 or the financial institution 230 at block 310. As discussed above, the customer master data includes information about the seller. As discussed above, the customer master data may include current payment and remittance methods, for example.

As another example, the customer master data may be received from a seller through the financial institution 220.

In certain embodiments, the receipt of the customer master data is logged. The receipt of the customer master data may be logged by the collaborative payment application 240, for example. The logging may be used by the system 200 to track whether and when seller information has been uploaded and report the status of batch jobs and manual processes, such as the stages of loading and evaluation.

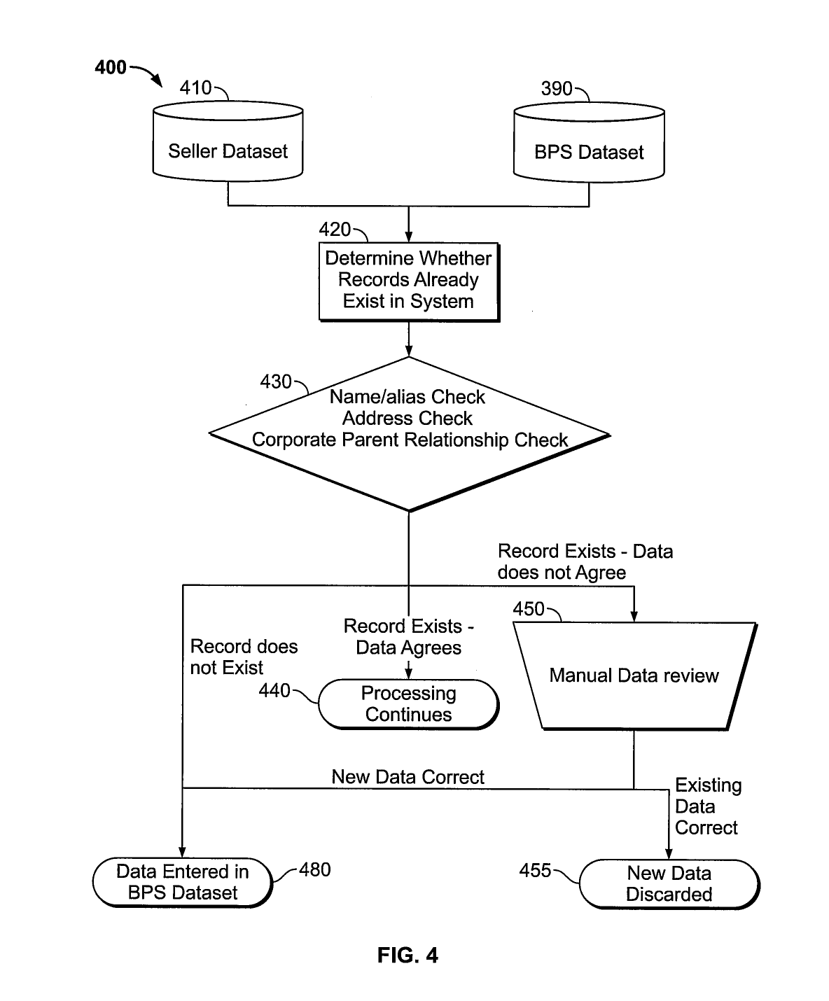

Next, at block 320, the data received at block 310, described above, is converted to a format for use in the database 390 of the collaborative payment application 240. The conversion of the received data is described below in more detail with reference to FIG. 4.

Then, at block 330, the data converted at block 320 is compared to data in the database 390. The comparison of the data is described below in more detail with reference to FIG. 4. The comparison may include running queries on the database 390. The comparison is made to determine whether the data is valid. That is, whether the data conforms to the proper format, is not a duplicate of data already in the database 390, and does not disagree with data in the database 390.

In certain embodiments, the collaborative payment application 240 displays the results of the comparison including one or more of the completion status; record counts for categories such as conforming, non-conforming, and disputed; and detailed exception records. The results may be presented to a user such as a system administrator through the user interface for the collaborative payment application 240, for example. For example, Seller A 230 may learn of a new buyer 210 capability for electronic receipt of payment which is then loaded into the database 390. Seller B 230 may then learn of the new capability (e.g., by being notified or by accessing the database 390). Seller B 230 may then update its operating procedures to take advantage of the new buyer 210 capability, potentially improving operating efficiency and/or reducing cost.

At block 340, a determination is made as to whether the data is valid. Valid data is data that conforms, is not a duplicate, and is non-disputed. The data conforms when it is in the proper format for inclusion in the database 390. The data is not a duplicate when it does not substantially duplicate data already stored in the database 390. The data is non-disputed when the data agrees with data already stored in the database 390.

If the data is a duplicate of data already included in the database 390, then, in certain embodiments, manual confirmation is made by a system administrator at block 350. If the system administrator determines the detection of duplicate data is correct, then the data is discarded at block 355. However, if the system administrator determines that the data is not duplicated, then the data is loaded into the database 390 at block 380, as described in more detail below.

Alternatively, in certain embodiments, if the data is determined to be a duplicate at block 340, it is automatically discarded, with no manual confirmation at block 350.

If the data is determined at block 340 to be inconsistent with the data in the database 390, then a determination is made at block 360 as to which data is correct. That is, at block 360, a determination is made as to whether the newly supplied data is correct or whether the data in the database 390 is correct. The “correct” data may be determined by evaluating the data to identify a more advanced capability as the correct data, for example. For example, if the database 390 indicates that the best known remittance capability for Buyer A is to include the typed remittance via paper submission along with a check and the data determined at block 340 received from Seller C indicates that Seller C is only aware that the Buyer A supports providing a fax upon request, then the “correct” best practice is the data currently in the database 390. As described below in more detail, Seller C may then be notified of the additional capabilities of Buyer A and the best practice indicating in the database 390. As another example, if, instead, the data from Seller C indicated that Buyer A supported transmission of remittance detail via CTX formatting on an ACH payment, then the newly supplied data from Seller C may be determined to be the “correct” data. The newly supplied data may still need to be manually confirmed as correct by a system administrator in certain embodiments.

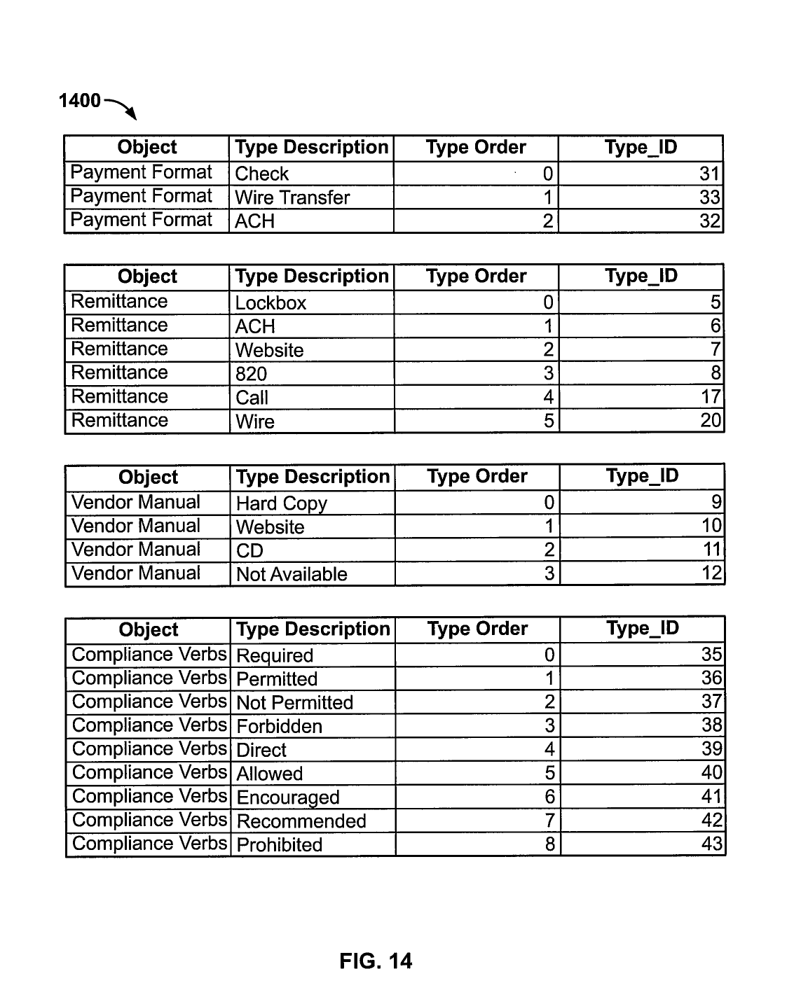

In certain embodiments, the determination of which data is correct may be made automatically. The automatic determination may be based on a ranking table of preferred capabilities, such as that illustrated in FIG. 14, described below in more detail.

In certain embodiments, the determination of which data is correct may be made manually. For example, a system administrator may review the data to determine which data is correct. The system administrator may research a particular payment or remittance capability, for example, to determine if the data is correct. As another example, the seller supplying the data may be queried to determine which data is correct.

If the new data is determined to be invalid, then it is discarded at block 355. That is, if the database 390 already includes the correct data, then the newly supplied data is discarded.

If the new data is determined to be correct, then the database 390 is updated at block 380.

At block 380, the data is loaded into the database 390.

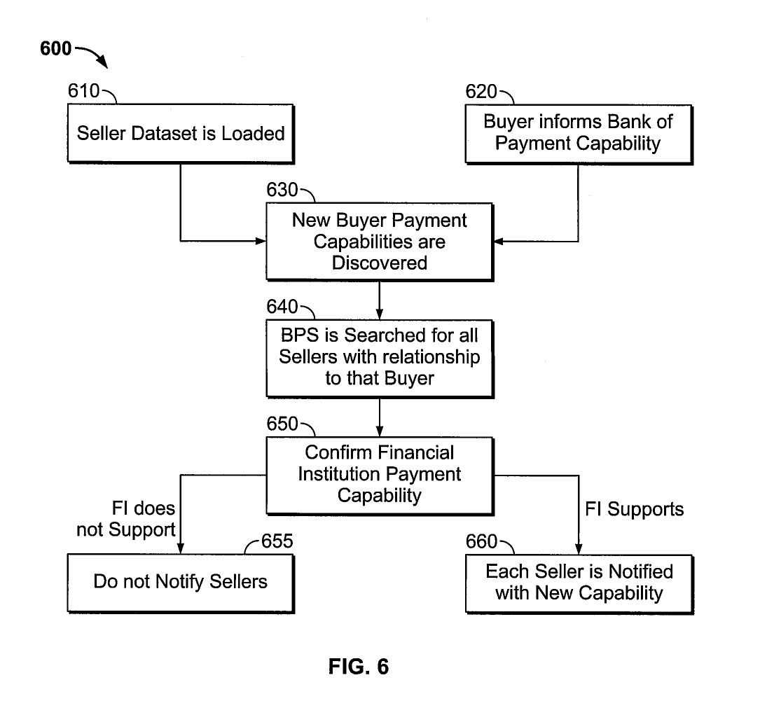

In certain embodiments, the collaborative payment application 240 notifies participants of the new data that has been loaded. The participants may be buyers 210 and/or sellers 230, for example. The participants may be notified by email, mail, or fax, for example. This notification is discussed below in more detail with reference to FIG. 6.

In certain embodiments, the collaborative payment application 240 includes a user interface adapted to display a form providing information to a user and/or prompting the user for information. For example, to facilitate operation discussed herein for the flow chart 300, the user interface may be adapted to prompt the user for the filename containing the customer master data. Other information may include seller information such as primary identity information including name, address, contact information, and/or integration/configuration status information. Other information may include file size, record count, record load status, a progress bar, error count, and/or error status. Status information may be indicated by an activity status type indicating one of not started, in process, and complete. Record status information may be indicated by a record status type indicating one of: ready for insertion, not ready for insertion—non-conforming, not ready for insertion—duplicate record, and not ready for insertion—in dispute. The user interface may support multiple dynamic style sheet configuration based on the financial institution 220.

In certain embodiments, a system administrator may manually load the new seller information into the database 390. The system administrator may utilize a user interface similar to that discussed above providing one or more screens that prompt the system administrator for information to be entered and notify the system administrator of progress and/or problems, for example. In reviewing each buyer record for a seller, the system administrator may first be prompted to indicate a data format and delivery technique.

If the buyer record does not exist, then it is entered. Data may be downloaded directly via electronic delivery or output to another file format. In certain embodiments, a system log is updated to indicate that the data is being routed via an alternate route.

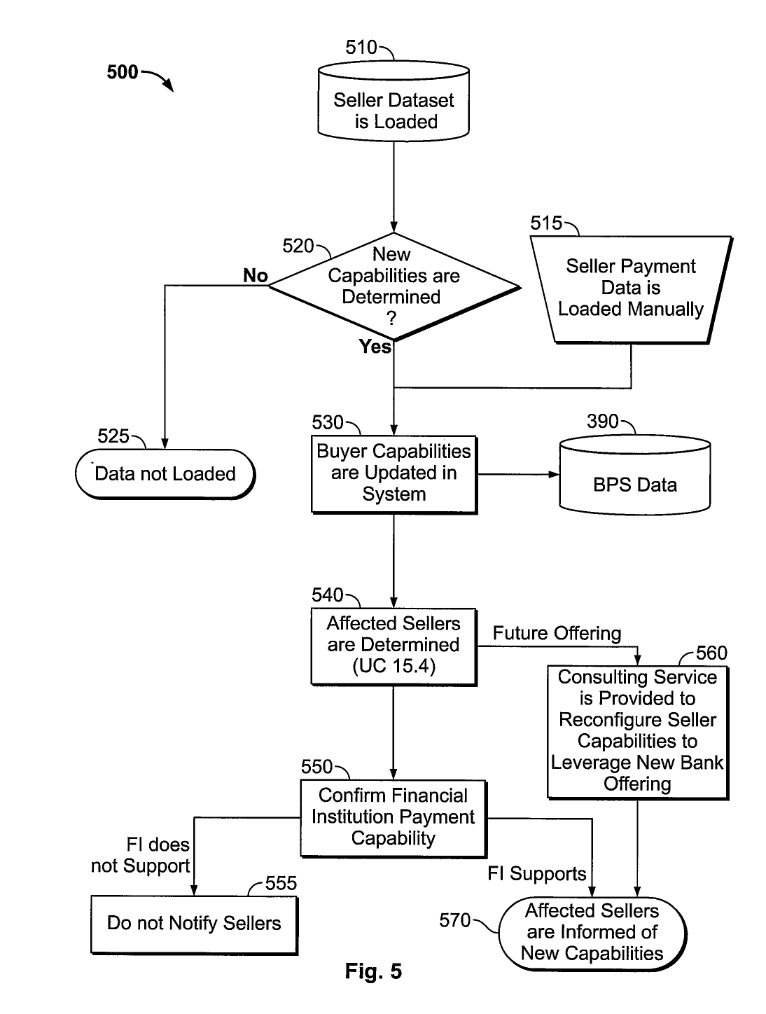

If the buyer record exists it is compared to the new record. The system administrator compares the existing records to the new records. If necessary, the system administrator researches payment and/or remittance capabilities to resolve any conflicts. The system administrator then updates the data using a workflow similar to that described below with reference to FIG. 5.

The system administrator may then notify participants of the new capabilities. The participants may be buyers 210 and/or sellers 230, for example. The participants may be notified by email, mail, or fax, for example. This notification is discussed below in more detail with reference to FIG. 6.

In certain embodiments, the collaborative payment application 240 is adapted to allow a system user to save a batch during processing and allow another system user to finish the processing. In certain embodiments, the collaborative payment application 240 is adapted to allow only a single system user to make changes at a time and other system users may view the data read-only. In certain embodiments, the collaborative payment application 240 is adapted to allow changes made on the payment detail interface to be applied to more than one record at a time. In certain embodiments, the collaborative payment application 240 is adapted to track changes made to all records. The changes may be tracked using, for example, user and/or date/time stamp information.

FIG. 4 illustrates a flow chart 400 of the comparison of seller information in the collaborative payment application 240 according to an embodiment of the present invention. More particularly, the flow chart 400 illustrates the comparison of seller information, described above in part with respect to the flow chart 300 illustrated in FIG. 3, with data in the database 390.

Typically, before the operation illustrated in the flow chart 400 occurs, the database 390 is populated with data. For example, the database 390 may include data from various participating sellers 230. The new seller 230 whose information is to be compared typically will have signed up for the collaborative payment processing service provided by the collaborative payment system 200. In addition, typically the new seller 230 and/or the financial institution 220 will supply the seller information, or “customer master data,” that is to be compared with the data in the database 390. Also, the load process, discussed above with respect to FIG. 3, will have started execution.

After the operation illustrated in the flow chart 400, which is described in more detail below, occurs, the data has been compared to the existing datasets. Non-duplicate, conforming data has been tagged for insertion and duplicate and/or non-conforming data has been tagged for further inspection.

The activities discussed below regarding the flow chart 400 are typically performed in a loop for each new data set to be compared as part of the loading process. That is, when multiple new sellers 230 are joining the collaborative payment system 200, their respective seller information may be batch loaded.

At block 420, seller information 410 is examined to determine if the seller information 410 already exists in the database 390. The seller information 410 may be similar to the data received at block 310, described above, for example.

At block 430, names and/or aliases in the seller information 410 are checked with data in the database 390. In addition, address information is checked. Also, a corporate parent relationship check is made to handle the case of an organization consisting of multiple legal entities who share a common Accounts Payable and/or Accounts Receivables platform, and/or to avoid creation of a duplicate record in the database 390. That is, when various entities are related and/or share common payment and/or remittance platforms, a single entry with multiple aliases is preferably used the database 390, rather than multiple entries. Consequently, when a search is made to add an entry and the name is an alias, the alias will point to the main entry. These checks are made using queries into the database 390.

If the seller information about buyer capabilities and preferences 410 is already in the database 390 and the seller information 410 agrees with the data in the database 390, then the seller information 410 is tagged to indicate that the data already exists and that it agrees. In certain embodiments, this duplicate seller information 410 is then queued for manual review by a system administrator to verify it is actually duplicate information. Processing then continues at block 440 for another set of seller information 410.

If the seller information 410 does not exist in the database 390, then the new seller information 410 is entered into the database 390 at block 480.

If the seller information 410 does not agree with the data in the database 390, then, in certain embodiments, the seller information 410 is tagged to indicate that the new seller information 410 does not agree with data already in the database 390. One or both of the new seller information 410 and the conflicting data in the database 390 may be queued for manual review by a system administrator. As discussed above with respect to FIG. 3, the system administrator may research the seller information to resolve the conflict in the data.

In certain embodiments, manual review of the data is performed by a system administrator at block 450. If the system administrator determines that the new seller information 410 is correct, then the new seller information 410 is entered into the database 390 at block 480. However, if the system administrator determines that the data in the database 390 is correct rather than the seller information 410, then the seller information 410 is discarded at block 455.

Alternatively, in certain embodiments, the determination of which data, the new seller information 410 or the data in the database 390, is correct is performed automatically. For example, if the new seller information 410 reflects a lower level of technical capability for payment processing by buyer 210 that is indicated by the data in the database 390, then the data in the database 390 is treated as correct and is retained. The seller 230 providing the new seller information 410 may then be alerted that the buyer 210 supports a greater level of technical capability than was known by the seller 230.

FIG. 5 illustrates a flow chart 500 of the maintenance of seller information in the collaborative payment application 240 according to an embodiment of the present invention. More particularly, the flow chart 500 illustrates the maintenance of seller information, described above in part with respect to the flow chart 300 illustrated in FIG. 3. Under this process, a system administrator may manually update the seller information in the database 390 or the data may be batch loaded into the database 390.

Typically, before the operations illustrated in the flow chart 500 occur, the database 390 is populated with data. For example, the database 390 may include data from participating sellers 230. The seller 230 whose information is to be maintained typically will have signed up for the collaborative payment processing service provided by the collaborative payment system 200. In addition, typically the seller 230 and/or the financial institution 220 will supply have supplied the collaborative payment application 240 with current payment and remittance records.

After the comparison illustrated in the flow chart 500, which is described in more detail below, occurs, the seller information has been updated.

When the system administrator manually updates seller information in the database 390, the system administrator will first receive the information. The information may be received via email, fax, or phone call, for example. The seller information may be received from the seller 230 and/or the financial institution 220, for example. The system administrator may learn of a changed buyer payment or remittance capability from trade associations, subscription services, direct buyer communication or financial institution collaboration, for example. The system administrator will then log into the collaborative payment application 240, when prompted for login information. The system administrator will then either search for the appropriate seller or, in the case where the system administrator has only one entity to maintain, select self maintenance. The seller may be searched for using queries into the database 390, for example. Once the seller has been located, the system administrator updates the records in the database 390. In certain embodiments, the collaborative payment application 240 may then perform a cascade of related changes based on the updates as discussed herein.

When the data is batch loaded into the database 390, the seller information is received by the collaborative payment application 240. As above, the seller information may be received from the seller 230 and/or the financial institution 220, for example. Receipt of the data may be logged and processing is initiated. The records in the received data are processed sequentially or in parallel with the collaborative payment application 240 saving a record of the changes. In certain embodiments, the collaborative payment application 240 may then perform a cascade of related changes based on the updates as discussed herein.

The activities discussed below regarding the flow chart 400 are typically performed in a loop for each new data set to be compared as part of the loading process.

At block 510, seller payment data is received. The seller information may be received from a cash application or adjustment management system, for example. The cash application and/or adjustment management system may be similar to one or more of the systems described in U.S. patent application Ser. No. 10/866,015 filed Jun. 10, 2004, entitled “System and Method for Automated Incoming Payment and Invoice Reconciliation”; U.S. patent application Ser. No. 10/865,076 filed Jun. 10, 2004, entitled “System and Method for Automated Payment and Adjustment Processing”; or U.S. patent application Ser. No. 10/865,997 filed Jun. 10, 2004, entitled “System and Method for Seller-Assisted Automated Payment Processing and Exception Management”, each of which are herein incorporated by reference in their entirety. The seller payment data may be received incrementally or as a batch update, for example.

The seller information may be received via email, fax, or phone call, for example.

Next, at block 520, new capabilities are determined. Buyer capabilities may include, for example, the different ways that a buyer 210 sends payments (e.g., check, ACH, and wire) and remittance information (e.g., paper document with the check, via fax, via externally routed EDI 820, or via website visit), and whether that information is sent automatically or whether it is requested manually. The buyer's capabilities may also include an indication of the preferred methods of communication of the payment and/or remittance information, for example. A new buyer capability may be determined by monitoring how a buyer pays and sends remittance information to a seller by receiving updates from an automated cash application processor (e.g., block 510, described above). These updates may specify how the buyer transacted the payment with the seller. By comparing these updates against current database 390 entries for the buyer, new capabilities may be identified.

If no new capabilities are determined, the data is not loaded, per block 525. If new capabilities are determined, then those capabilities are updated in the system at block 530. That is, the new capabilities are stored in the database 390.

Alternatively, seller information may be loaded manually at block 515. Processing then proceeds to block 530, as described above.

Then, at block 540, affected sellers are determined. An affected seller is a seller affected by the new seller information. The affected sellers are determined and notified (block 570) as described in more detail below with respect to FIG. 6. The affected sellers are determined based upon the existence of a business relationship with the buyer who has added new capabilities. The affected sellers may be determined based at least in part on the technical sophistication of the seller to take advantage of the new capabilities. Thus, in some circumstances, only a subset of sellers with a relationship to the buyer may be determined to be affected if certain sellers lack the technical sophistication to take advantage of the new capability. The affected sellers may be alerted to permit them to assess the opportunity to achieve greater operational efficiencies and/or reduced operating costs through upgrading their payment practices with the subject buyer and/or subject financial institution.

Then, in certain embodiments, at block 550, the payment capabilities of the financial institution 220 are confirmed. That is, if the financial institution 220 is determined to not support the new capability of the buyer 210, then the related sellers 230 are not notified of the new capability at block 555. Conversely, if the financial institution does support the new capability, then processing proceeds to block 570.

In certain embodiments, at block 560, a consulting service may be provided to reconfigure seller capabilities to leverage a new offering by the financial institution 220. The consulting service may be provided by the business development staff of the host of the collaborative payment application 240 or the subject financial institution 220, for example. The consulting services may seek to inform the seller 230 of new or incremental opportunities for payment processing efficiencies based upon future product offerings, and to assist with financial return-on-investment analysis of the new or incremental opportunity.

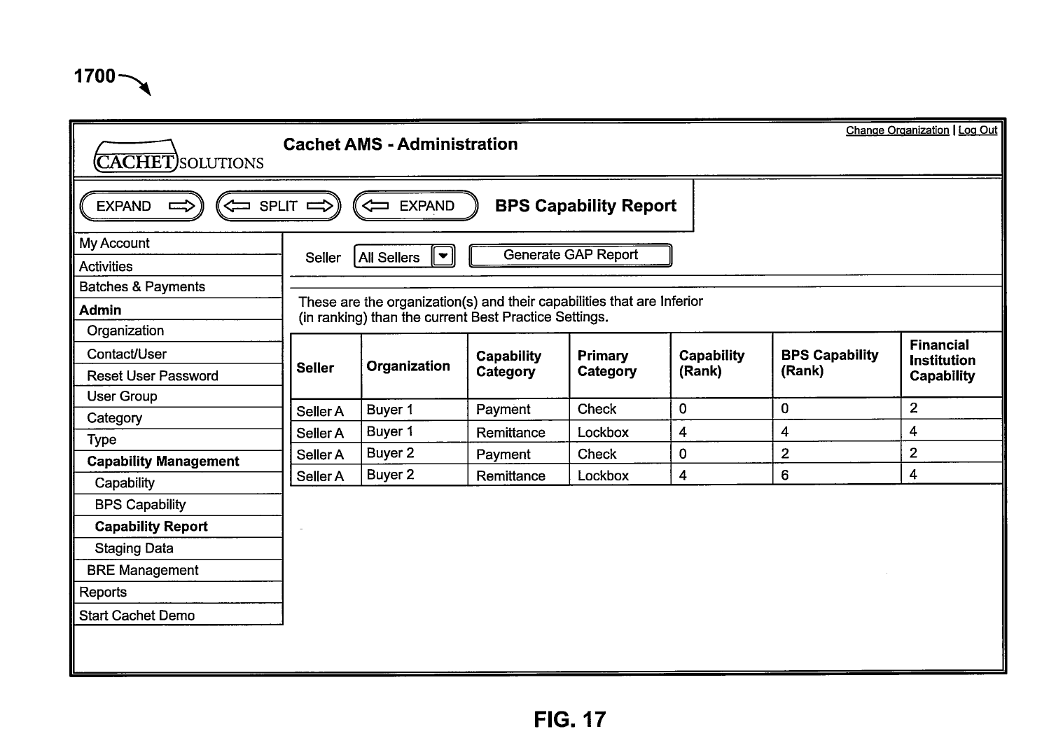

FIG. 17 illustrates a user interface 1700 for the collaborative payment application 240 showing the current configurations for buyers 210 associated with a particular seller 230 according to an embodiment of the present invention. The user interface 1700 indicates the current configuration for Seller A for Buyer 1 and Buyer 2, including the capability values and rankings. In addition, the financial institution 220 capabilities are identified. The user interface 1700 includes entries for “Seller”, “Organization”, “Capability Category”, “Primary Category”, “Capability (Rank)”, “BPS Capability (Rank)”, and “Financial Institution Capability.”

At block 570, the affected sellers are informed of the new capabilities. The affected sellers include the sellers determined at block 540, described above. The new capabilities include the new capabilities identified at blocks 520-530, described above. The affected sellers are notified as described in more detail below with respect to FIG. 6.

In certain embodiments, the collaborative payment application 240 includes a user interface adapted to display a form prompting a user to select a seller. Information for the seller that the user may be prompted to enter or verify includes primary identity information such as name, address, contact information, and integration/configuration status information. In addition, current payment and remittance receipt capabilities and preferences for the seller may be specified. The capabilities may include support transmission transport protocols such as AS2, EDI VAN, FTPS, and HTTPS, for example. The capabilities may include supported file format protocols such as ACH and EDI 820, for example. The capabilities may include version information for the various protocols, for example. The capabilities may include notes for the seller, for example.

FIG. 6 illustrates a flow chart 600 of the notification of sellers by the collaborative payment application 240 according to an embodiment of the present invention. More particularly, the flow chart 600 illustrates the notification of sellers of information about updated buyer capabilities, described in part above with respect to the flow chart 500 illustrated in FIG. 5. Sellers 230 typically desire to receive information about buyer 210 capabilities in an automated manner. As each buyer 210 signs up to participate in the collaborative payment system 200, the capabilities of the buyer 210 are updated in the database 390. Buyer capabilities may include payment capabilities, such as electronic payment. When a seller 230 has a different payment receipt format (that is, a more automatic and therefore preferable) from a given buyer 210 than that buyer 210 maintains with other sellers 230, then the other sellers 230 will be updated with this capability. The operation described in the flow chart 600 may occur when sellers 230 update the collaborative payment application 240 about changed capabilities for buyers 210 the sellers 230 deal with. Alternatively, the operation described in the flow chart 600 may occur when a buyer 210 chooses to update sellers 230 as a way of advertising to sellers new payment format capabilities of the buyer.

When a seller 230 submits an update to the collaborative payment application 240, in which seller information is loaded into the system using the process described above with respect to FIG. 3, the data is compared with data already in the database 390 using the process described above with respect to FIG. 4. When new buyer payment capabilities are discovered, sellers 230 having a relationship to the buyer 210 are notified using a preferred communication method.

When a buyer 210 directly alerts the financial institution 220 to its new payment capabilities, the information is logged into the database 390 and the new capabilities are disseminated to sellers 230 with relationships to the buyer 210. Alternatively, a change in the payment capabilities of a buyer 210 may be detected when a financial institution 220 receives a payment from the buyer 210 using a methodology not previously employed. Again, the new capabilities are then disseminated to sellers 230 with relationships to the buyer 210.

Typically, before the operation illustrated in the flow chart 600 occurs, the database 390 is populated with data. The seller 230 typically has signed up for the collaborative payment processing service provided by the collaborative payment system 200. In addition, typically the seller 230 and/or the financial institution 220 has supplied customer master data, including current payment and remittance methods. This seller information has been loaded into the database 390 and compared with other seller data as described above. Lastly, a new buyer payment format capability has been confirmed.

After the operation illustrated in the flow chart 600, which is described in more detail below, occurs, other sellers 230 have been notified of a new payment capability of a given buyer 210.

At block 610, seller information is loaded. The loading of seller information data is described above in the flow chart 300 illustrated in FIG. 3.

At block 620, a buyer 210 informs the financial institution 220 of a payment capability. Alternatively, as discussed above, the financial institution 220 may detect a change in payment capability of the buyer 210 when the buyer 210 submits a payment to the financial institution 220 using a methodology not previously employed by the buyer 210.

At block 630, new buyer payment capabilities are discovered. The new buyer payment capabilities are discovered when the buyer 210, at block 620, provides information of a payment capability that was not previously know. That is, if the payment capability of the buyer 210 was not previously stored in the database 390, then the capability is a new capability that has been discovered.

At block 640, the database 390 is searched to identify sellers 230 with a relationship with the buyer 210 that has had a new payment capability identified. The relationship between the buyer 210 and a particular seller 230 may be identified by the existence of buyer capability records in the particular seller's dataset.

Then, in certain embodiments, at block 650, the payment capabilities of the financial institution 220 are confirmed. That is, if the financial institution 220 is determined to not support the new capability of the buyer 210, then the related sellers 230 are not be notified of the new capability at block 655. If the financial institution does support the new capability, then processing proceeds to block 660.

At block 660, each seller 230 identified at block 640, described above, is notified regarding the new payment capability. The sellers 230 may be notified via mail, email, fax, or telephone, for example.

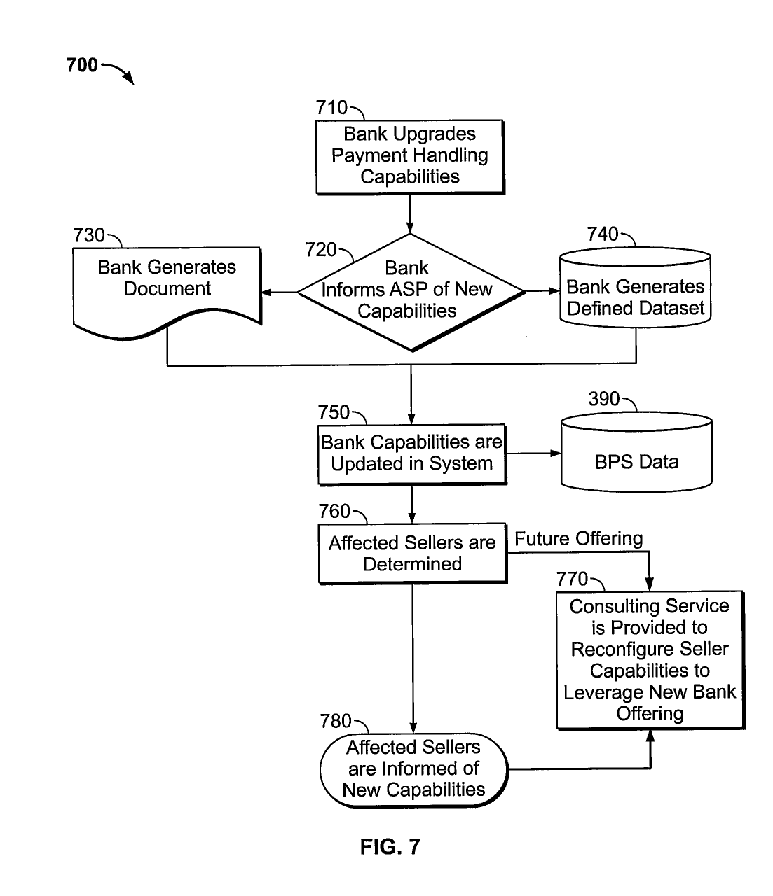

FIG. 7 illustrates a flow chart 700 of the maintenance of capabilities of a financial institution 220 in the collaborative payment application 240 according to an embodiment of the present invention. More particularly, the flow chart 700 illustrates maintaining payment handling capabilities of the financial institution 220. Financial institutions such as financial institution 220 have different capabilities or proficiencies at handling payments and remittance data. For example, Bank 1 may be particularly efficient at handling data via a wholesale lockbox (that is, checks and paper remittance), but less efficient at handling electronic payments such as ACH. Bank 2, on the other hand, may have efficiencies opposite those of Bank 1. Thus, although a buyer 210 may be capable of electronic payment and remittance, if the buyer 210 works with Bank 1, the best practice for the buyer 210 may be to submit payment via check and attached paper remittance. On the other hand, if the buyer 210 worked with Bank 2, the electronic handling may be the best practice. In addition, payment handling and remittance handling may operate independently of each other. So, for example, Bank 3 might be able to handle ACH payments efficiently, but not efficiently handle CTX formatting that includes the remittance information. These different capabilities may be a result of, for example, varying degrees of investment in payment processing capabilities by financial institutions and/or from financial institutions having been formed from mergers of other financial institutions and capabilities may not have been standardized yet.

The operation shown in flow chart 700 and discussed below may occur when a system administrator loads information individually or when data is batch loaded into the database 390.

When the system administrator loads information individually, the collaborative payment application 240 logs receipt of the new information regarding the payment handling capabilities of the financial institution 220. The system administrator reviews and loads the data into the collaborative payment application 240 which stores the data in the database 390, determines which sellers 230 are affected by the new capabilities, and notifies those sellers 230.

When the data is batch loaded into the database 390, the above steps are performed automatically.

Typically, before the operation illustrated in the flow chart 700 occurs, the database 390 is populated with data. In addition, the financial institution 220 has signed up for the collaborative payment processing service provided by the collaborative payment system 200. Also, typically the financial institution 220 has supplied lockbox and payment handing information to the collaborative payment application 240 which is then stored in the database 390.

After the operation illustrated in the flow chart 700, which is described in more detail below, occurs, the collaborative payment system 200 is updated and if information has been changed, existing financial institution 220 customers (that is, buyers 210 and/or sellers 230) are alerted to the new payment handling capabilities of the financial institution 220.

At block 710, the financial institution 220 alters its payment handling capabilities. For example, a bank may add new or incremental capabilities in areas such as imaging or data transmission to expand or upgrade their commercial offerings.

Then, at block 720, the financial institution 220 informs the collaborative payment application 240 of the change in payment handling capabilities of the financial institution 220. The financial institution 220 notifies the collaborative payment application 240 of the changed payment handling capabilities of the financial institution 220 manually (e.g., using a paper document) at block 730 or electronically (e.g., using a generated dataset) at block 740.

At block 750, the collaborative payment application 240 updates the payment handling capabilities of the financial institution 220. The updated information regarding the payment handling capabilities of the financial institution 220 is stored in the database 390.

Next, sellers 230 affected by the change in the payment handling capabilities of the financial institution 220 are determined.

In certain embodiments, at block 770, a consulting service may be provided to reconfigure seller capabilities to leverage a new offering by the financial institution 220 such as the changed payment handling capability. The consulting service may be provided by the business development staff of the host of the collaborative payment application 240 or the subject financial institution 220, for example. The consulting services may seek to inform a seller 230 of new or incremental opportunities for payment processing efficiencies based upon future product offerings, and to assist with financial return-on-investment analysis of the new or incremental opportunity.

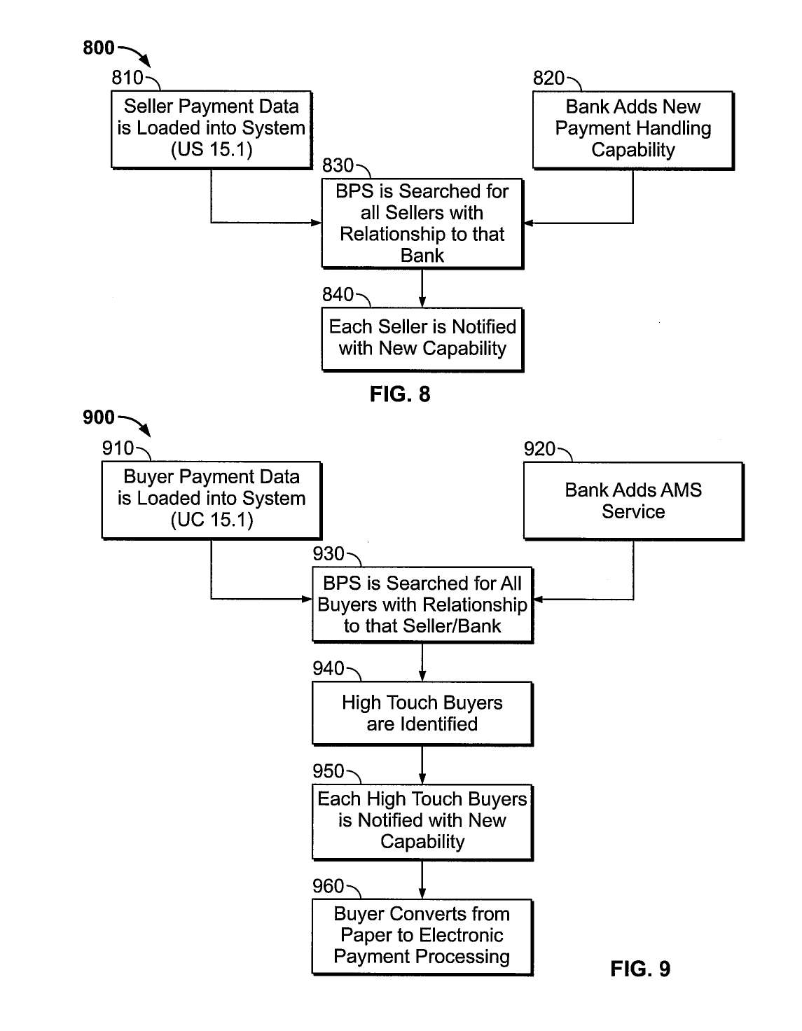

At block 780, the affected sellers are informed of the new capabilities. The affected sellers include the sellers determined at block 760, described above. The affected sellers are notified using the process described below with respect to FIG. 8.

In certain embodiments, the collaborative payment application 240 includes a user interface adapted to display a form prompting a user to provide a filename for a customer master file. The user interface may request information such from the user, or the file, such as filename, financial institution information, and financial institution identity information (including, e.g., name, address, contact information, and integration/configuration status information). In addition, detail for each lockbox site may include platform and version information, data capture capabilities (such as hours of operation, frequency of batch delivery, handling capacity, and service area), image handling capabilities, data keying/OCR (Optical Character Recognition) capabilities, EDI/XML/BAI (Banking Administration Institute) data pass through capabilities, and supported outbound data formats. The user interface may support multiple dynamic style sheet configuration based on the financial institution 220.

FIG. 8 illustrates a flow chart 800 of the notification of sellers by the collaborative payment application 240 according to an embodiment of the present invention. More particularly, the flow chart 800 illustrates the notification of sellers of updated financial institution payment capabilities, described above with respect to FIG. 7. The operation described in flow chart 800 may include automatically notifying sellers 230 via communication mediums such as email, letter, fax, or phone call. Alternatively, data for sellers 230 with relationships to financial institutions 220 and/or buyers 210 may be evaluated and a consulting strategy may be developed and offered to the seller 230. For example, a report of each seller's buyers that could benefit from the changed capabilities may be generated. A system administrator may then analyze each buyer and determine what seller technology or process may be changed to accommodate the new capability. The system administrator may then prepare a cost-benefit analysis and cost estimate for the seller and present the analysis to the seller's representative.

Typically, before the operation illustrated in the flow chart 800 occurs, the database 390 is populated with data. In addition, the seller 230 has signed up for the collaborative payment processing service provided by the collaborative payment system 200. Also, typically the seller 230 and/or the financial institution 220 has supplied customer master data with current payment and remittance methods and financial institution 220 capabilities have been updated.

After the operation illustrated in the flow chart 800, which is described in more detail below, occurs, sellers 230 have been informed of the new capabilities of the financial institution 220. Also, in some embodiments, the seller may change buyer payment and remittance delivery.

At block 810, seller payment data is loaded. The loading of seller payment data is described above in the flow chart 300 illustrated in FIG. 3.

At block 820, financial institution 220 changes its payment handling capabilities, as discussed above in the flow chart 700 illustrated in FIG. 7.

At block 830, the database 390 is searched to identify sellers 230 with a relationship to the financial institution 220. Sellers may be identified based on a data tag in the database 390 denoting a relationship between a seller and a financial institution.

Then, at block 840, each seller 230 identified at block 830, described above, is notified regarding the new payment handing capability. A seller 230 may be notified via mail, email, telephone, or fax, for example. As another example, sellers 230 may be notified via a task list created for that seller 230.

FIG. 9 illustrates a flow chart 900 of the notification of buyers by the collaborative payment application 240 according to an embodiment of the present invention. More particularly, the flow chart 900 illustrates the notification of buyers of updated financial institution payment capabilities, described in part above with respect FIG. 7.

Some buyers 210 may not take advantage of electronic payment processing and handling capabilities. This may be because, in part, the buyer 210 sees the marginal cost associated with adding that capability. However, once a critical mass of sellers 230 (and financial institutions 220) has the requisite capabilities to handle electronic payments and remittances, then it makes sense for the collaborative payment system 200 to inform buyers 210 of the newly available techniques and educate them to the potential cost savings. These buyers 210 are referred to as “high touch” buyers. For example, a buyer with 50 suppliers, who are customers of a particular financial institution and are participants in the collaborative payment system 200, may be notified that an improvement to the financial intuition's payment, remittance detail and debit memo submission process may benefit the buyer's payables processing and collective supply chain and lower costs as a result.

In an embodiment, a system administrator may monitor buyer 210 capabilities and seller relationship counts. This monitoring may be done using reports of financial institutions 220, sellers 230, and buyers 210 provided by the collaborative payment application 240. The collaborative payment application 240 may highlight buyers 210 who have a threshold number of seller 230 relationships that they would be interested in knowing about the advantage of switching to a new payment processing technology. Once buyers 210 have been identified, the system administrator may develop a cost-benefit analysis to illustrate the advantage of moving from paper to electronic processing. The system administrator may then provide consulting services to the buyer 210 to make the switch.

In certain embodiments, high touch or priority buyers 210 are notified using the process described in flow chart 900. A priority buyer may be a buyer 210 with a threshold number of sellers 230 which the buyer 210 has a relationship with that support the new capability, for example.

In certain embodiments, each affected buyer 210, whether or not the buyer 210 is a priority buyer, is notified.

Typically, before the operation illustrated in the flow chart 900 occurs, the database 390 is populated with data. In addition, the financial institution 220 has signed up to participate in the collaborative payment processing service provided by the collaborative payment system 200 and has electronic handling capability. Also, typically the financial institution 220 has provided lockbox and payment handling information. Further, a critical mass of sellers 230 have signed up for the collaborative payment system 200 and have electronic processing capability.

After the operation illustrated in the flow chart 900, which is described in more detail below, occurs, buyers 210 have been informed of the new capabilities. Also, in some embodiments, a buyer 210 convert from paper processing to electronic processing.

At block 910, buyer payment data is loaded. The loading of buyer payment data (as supplied by sellers through seller information at block 410, for example, as discussed above) is described above in the flow chart 300 illustrated in FIG. 3.

At block 920, financial institution 220 changes its payment handling capabilities, as discussed above in the flow chart 700 illustrated in FIG. 7. Changes in capability for buyers and sellers are processed as discussed in other flow charts.

At block 930, the database 390 is searched to identify buyers 210 with a relationship to the financial institution 220. The high touch buyers, as described above, are identified at block 940.

Then, at block 950, each buyer 210 identified at block 940, described above, is notified regarding the new payment handing capability. The buyers 210 may be notified may be notified via mail, email, telephone, or fax, for example.

At block 960, a buyer converts from paper to electronic payment processing after being notified of the new financial institution payment handling capability.

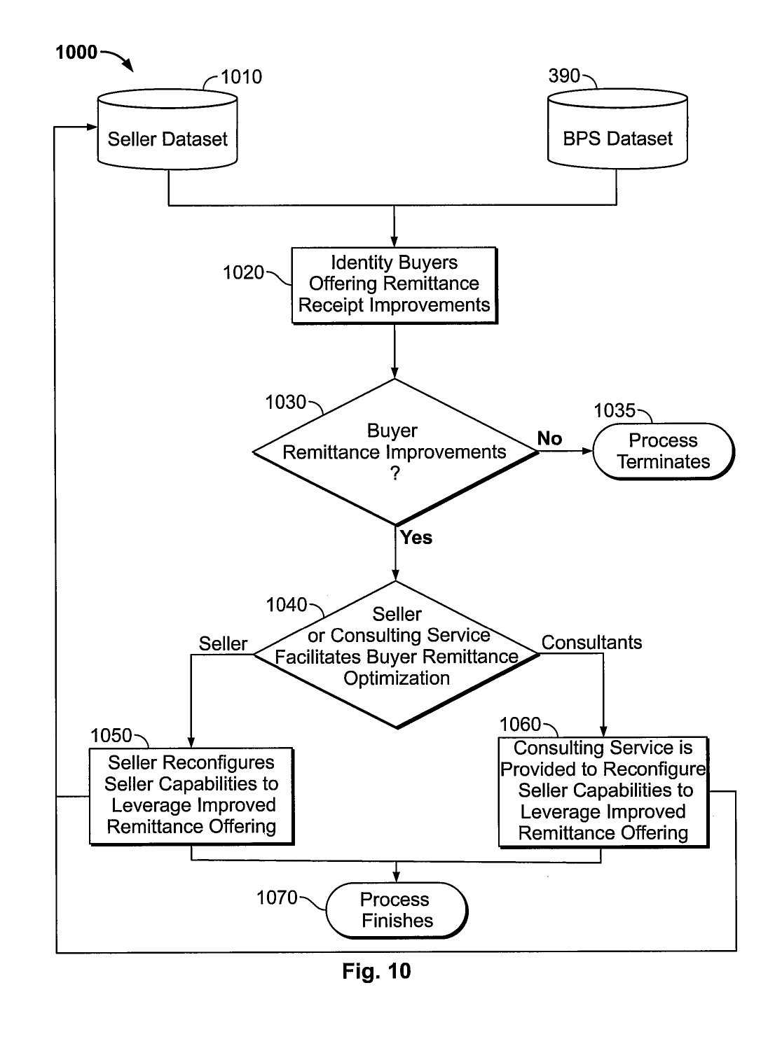

FIG. 10 illustrates a flow chart 1000 of the optimization of seller payment/remittance processing by the collaborative payment application 240 according to an embodiment of the present invention. More particularly, the flow chart 1000 illustrates the optimization of seller payment/remittance processing given a set of financial institution 220 and buyer 210 capabilities. In general, the goal is to automate the processing of payment and remittance to the greatest extent possible at the lowest possible transaction price using available information. In certain embodiments, a best fit combination is determined.

When data is updated in the database 390, the optimization process illustrated in flow chart 1000 may be invoked. Each seller 230/buyer 210 combination may be evaluated. The evaluation may include payment type and remittance type compatibilities and a comparison of the current configuration to a “best available” configuration that is determined based on a ranking table. The ranking table may include a list of known delivery and formatting techniques as well as a set of relationships reflecting compatibilities among various technologies and a field indicating most to least desirable. If the current configuration does not match the “best available” configuration, then a change is suggested by the collaborative payment application 240. The suggestion may be provided in a report to a system administrator showing each recommended seller/buyer/financial institution configuration change along with summary statistics.

FIG. 14 illustrates an exemplary ranking table 1400 according to an embodiment of the present invention. The ranking table may specify a ranking or ordering of different capabilities, for example. For example, the “PaymentFormat” capability may include three types “Check,” “Wire Transfer,” and “ACH” that may in turn be ranked or ordered “0,” “1,” and “2,” respectively, as illustrated in FIG. 14.

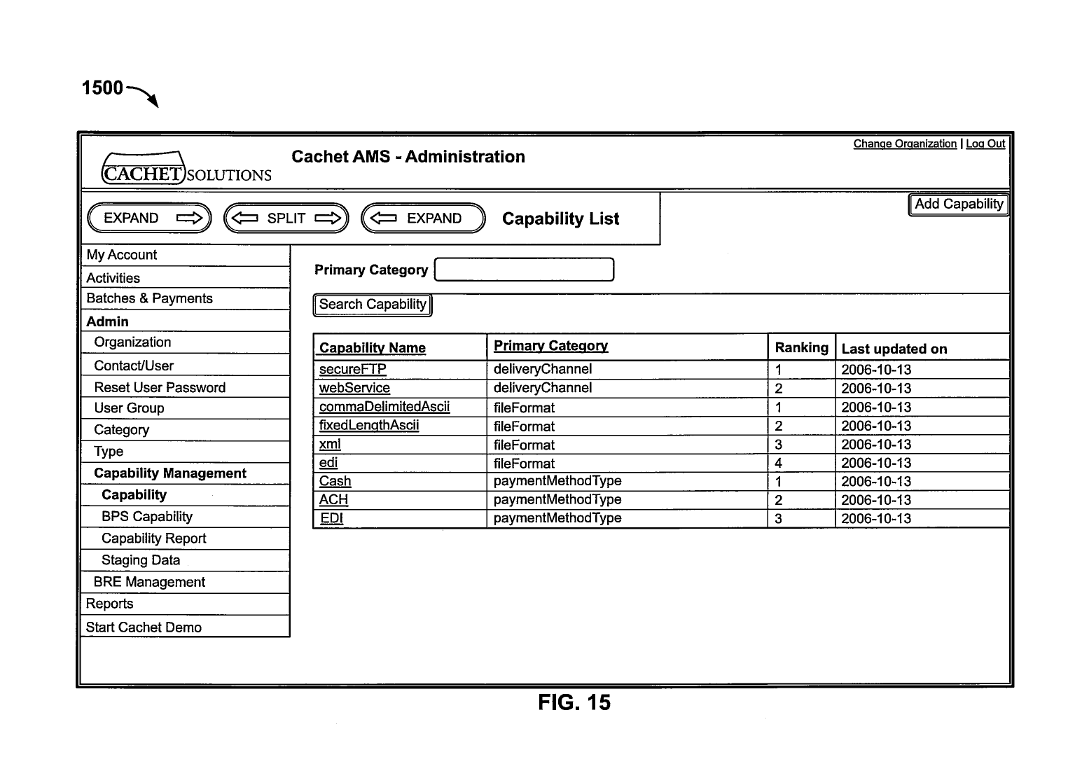

FIG. 15 illustrates another exemplary ranking table 1500 according to an embodiment of the present invention. As with the ranking tables discussed above, the ranking table 1500 provides rankings of capabilities. For example, “secureFTP” and “webService” may be two capabilities in the “deliveryChannel” category that may be ranked “1” and “2,” respectively, as illustrated in FIG. 15. In addition, the ranking table 1500 includes entries for “Capability Name”, “Primary Category”, “Ranking”, and “Last Updated”.

Returning now to FIG. 10, typically, before the operation illustrated in the flow chart 1000 occurs, the database 390 is populated with data. The financial institution 220, buyers 210, and sellers 230 typically have signed up for the collaborative payment processing service provided by the collaborative payment system 200. In addition, typically the seller 230 and/or the financial institution 220 has supplied customer master data, including current payment and remittance methods. Also, typically, a capability ranking/compatibility table exists in the database 390 for payment and remittance data formats and transmission technologies.

When the data in the database 390 is updated (as described above, for example, with reference to FIGS. 3, 5, 7), the operation illustrated in flow chart 1000 occurs.

After the operation illustrated in the flow chart 1000, which is described in more detail below, occurs, each buyer payment/remittance combination is evaluated and suggested improvements are given.

At block 1020, buyers 210 offering remittance delivery improvements are identified. The buyers 210 may be identified by independent research by the collaborative payment application 240 provider or when a seller 230 updates the database 390 based on a specific experience with the buyer 210, for example. The buyer 210 may be identified using an organization name, stock ticker symbol, or assigned identification number, for example.

At block 1030, if no remittance improvements are offered by a buyer 210, the optimization process terminates at block 1035. Otherwise, when a remittance improvement is available, at block 1040, optimization is performed. The optimization may include, as discussed above, a determination of a best available configuration of the entities and capabilities.

At block 1050, a seller reconfigures seller capabilities to leverage the improvement. The reconfigured seller capabilities are then stored in the seller dataset 1010. For example, if a buyer transitions from providing checks to providing electronic transfers, then that transition is reported to a plurality of sellers dealing with the buyer. The sellers may then update and reconfigure their methodology for receiving payment from the buyer so that the seller then expects to receive payment from the buyer in an electronic transfer rather than in a check. Thus, when a change is identified on the basis of a comparison to the previous method used, the change may be sent to the system administrator for confirmation and loaded into the database 390.

At block 1060, a consulting service is provided to reconfigure seller capabilities to leverage the improvement. For example, instead of the seller internally updating the seller's information, a consulting service may be positioned to perform the updating of the seller's information for the seller. The consulting service may be provided by the business development staff of the host of the collaborative payment application 240 or the subject financial institution 220, for example. The consulting services may seek to inform the seller 230 of new or incremental opportunities for payment processing efficiencies based upon future product offerings, and to assist with financial return-on-investment analysis of the new or incremental opportunity.

At block 1070, the optimization process finishes.

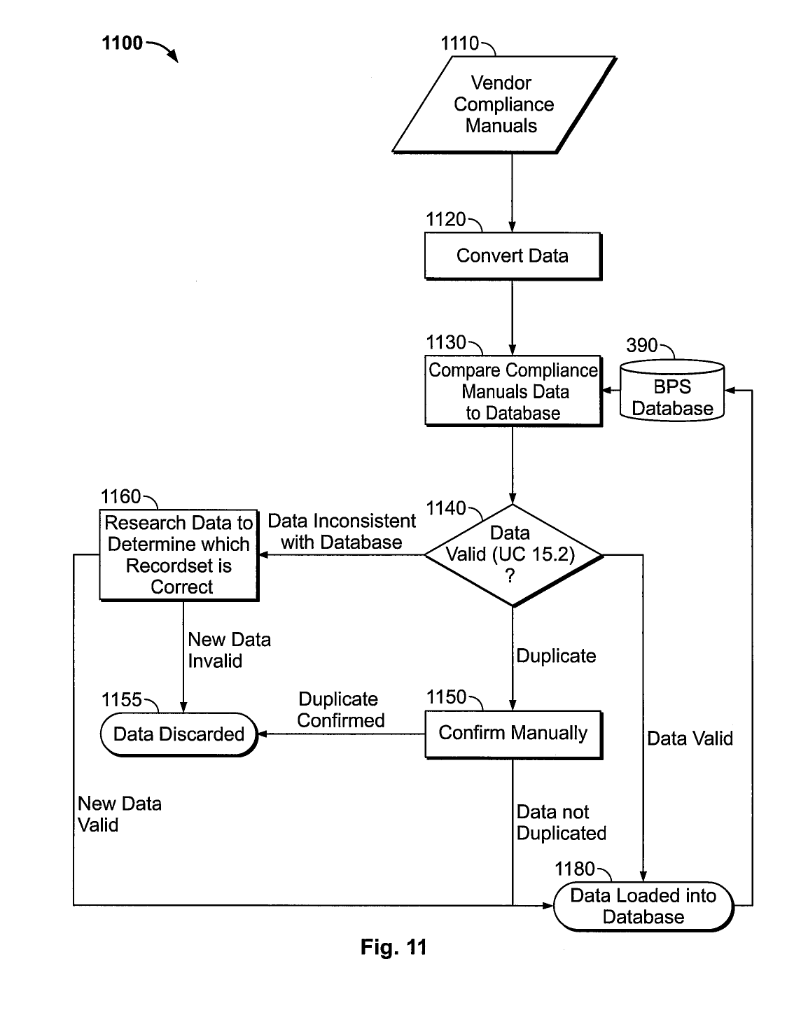

FIG. 11 illustrates a flow chart 1100 of the operation of the collaborative payment application 240 according to an embodiment of the present invention. More particularly, the flow chart 1100 illustrates the loading of buyer compliance guideline information into the database 390. This operation may occur when a new buyer entry is created in the collaborative payment system 200, for example. Alternatively, the operation illustrated in flow chart 1100 may occur when a seller 230 has access to buyer compliance guideline information and provides that to the collaborative payment application 240 to be loaded into the database 390. The buyer compliance guideline information may be used to catalog those requirements which outline the techniques preferred by the buyer for conducting business with the buyer. For example, the buyer compliance guideline information may specify information such as codes for products, codes for compliance rules which can be referenced on remittance information or debit memos, minimum non-compliance fees per a specified violation, additional fees for multiple instances of a single code violation, maximum fees per code violation, penalty fees for repeat instances of the same violation, points of contact at buyer organization to manage account inquiries, merchandise shipping guidelines, carrier selection guidelines, labeling requirements for products and packaging, and EDI compliance requirements, for example.

The buyer compliance guideline information is loaded in a manner similar to the loading of seller information discussed above with respect to FIG. 3 and flow chart 300.

The buyer compliance guideline information may be batch loaded in the database 390. That is, a set of data for one or more buyers 210 is loaded at one time in an automatic manner. Alternatively, the data may be loaded by a system administrator. The system administrator may load the buyer compliance guideline information individually, for example.

When the buyer compliance guideline information is batch loaded into the database 390, first it is received from the buyer 210. The collaborative payment application 240 may log the receipt of the information. The buyer compliance guideline information may then be converted and compared to data existing in the database 390 to determine whether the data is conforming, non-duplicate, non-disputed data. If the data is non-conforming, a system administrator may correct the errors. If the data is a duplicate of that already stored, a system administrator may be asked to verify this. If the data disagrees with data stored in the database 390, a system administrator may be prompted to manually review the records to resolve the dispute. Sellers 230 may then be notified of the new buyer compliance guideline information by email, mail, or fax, for example.

When the buyer compliance guideline information is manually loaded, a system administrator may review the buyer compliance guideline information and the collaborative payment application 240 may prompt the system administrator to indicate data format and delivery technique. If the buyer record does not exist, it is entered into the system and data is downloaded directly via electronic delivery or is output to another file format for either electronic or manual delivery. A transaction log may be updated to indicate that the batch is being routed via an alternate route. If the buyer record exists, the system administrator compares the existing records to new records. The system administrator may research buyer information and update the data stored in the database 390. The system administrator then notifies sellers 230 of the new buyer compliance guideline information via email, mail, or fax, for example.

Typically, before the loading illustrated in the flow chart 1100 occurs, the database 390 is populated with data. For example, the database 390 may include data for buyers 210 and sellers 230 who have signed up for the collaborative payment processing service provided by the collaborative payment system 200. In addition, typically the sellers 230 and/or the financial institution 220 will have supplied customer master data. The customer master data may include current payment and remittance methods, for example.

After the loading illustrated in the flow chart 1100, which is described in more detail below, occurs, the buyer compliance guideline information has been loaded into the database 390. Typically, the information has been deduped (that is, duplicate information has been removed) using a process similar to that described above with reference to FIG. 4. In addition, a system administrator may be assigned to review any difference between the newly loaded data and existing data.

First, buyer compliance guideline data is received at block 1110. As discussed above, the buyer compliance guideline data may be received from a buyer 210. Alternatively, the buyer compliance guideline data may be received from a seller 230 when the seller 230 has access to the data. The buyer compliance guideline data represents information about the buyer 210. More particularly, the buyer compliance guideline data represents the buyer's vendor compliance manual.

Next, at block 1120, the data received at block 1110, described above, is converted to a format for use in an adjustment management system of a financial institution 220.

Then, at block 1130, the data converted at block 1120 is compared to data in the database 390. The comparison may include running queries on the database 390. The comparison is made to determine whether the data is valid. That is, whether the data conforms to the proper format, is not a duplicate of data already in the database 390, and does not disagree with data in the database 390. The comparison may be similar to the comparison illustrated in FIG. 4, described above.

At block 1140, a determination is made as to whether the data is valid. This determination is similar to that made in the flow chart 400 illustrated in FIG. 4, discussed above. Valid data is data that conforms, is not a duplicate, and is non-disputed. The data conforms when it is in the proper format for inclusion in the database 390. The data is not a duplicate when it does not substantially duplicate data already stored in the database 390. The data is non-disputed when the data agrees with data already stored in the database 390.

If the data is a duplicate of data already included in the database 390, then, in certain embodiments, manual confirmation is made by an administrator at block 1150. If the administrator determines the detection of duplicate data is correct, then the data is discarded at block 1155. However, if the administrator determines that the data is not duplicated, then the data is loaded into the database 390 at block 1180, as described in more detail below.

Alternatively, in certain embodiments, if the data is determined to be a duplicate at block 1140, it is automatically discarded, with no manual confirmation at block 1150.

If the data is determined at block 1140 to be inconsistent with the data in the database 390, then a determination is made at block 1160 as to which data is correct. That is, at block 1160, a determination is made as to whether the newly supplied data is correct or whether the data in the database 390 is correct. In certain embodiments, the determination of which data is correct may be made automatically.

In certain embodiments, the determination of which data is correct may be made manually. For example, a system administrator may review the data to determine which data is correct. The system administrator may research a the particular capabilities of a buyer 210 and/or seller 230, for example, to determine which data is correct. As another example, the buyer 210 supplying the data may be queried to determine which data is correct.

If the new data is determined to be invalid, then it is discarded at block 1155. That is, if the database 390 already includes the correct data, then the newly supplied data is discarded.

If the new data is determined to be correct, then the database 390 is updated at block 1180.

At block 1180, the data is loaded into the database 390.

In certain embodiments, the collaborative payment application 240 includes a user interface. The user interface may display a form providing information to a user and/or prompting the user for information. For example, to facilitate operation discussed herein for the flow chart 1100, the user interface may be adapted to prompt the user for the filename containing the buyer compliance guideline information. Other information may include seller information such as primary identity information including name, address, contact information, and/or integration/configuration status information. Other information may include file size, record count, record load status, a progress bar, error count, and/or error status. Status information may be indicated by an activity status type indicating one of not started, in process, and complete. Record status information may be indicated by a record status type indicating one of: ready for insertion, not ready for insertion—non-conforming, not ready for insertion—duplicate record, and not ready for insertion—in dispute. The user interface may support multiple dynamic style sheet configuration based on the financial institution 220.

In certain embodiments, the collaborative payment application 240 is adapted to allow a system user to save a batch during processing and allow another system user to finish the processing.

In certain embodiments, the collaborative payment application 240 is adapted to allow only a single system user to make changes at a time and other system users may view the data read-only.

In certain embodiments, the collaborative payment application 240 is adapted to allow buyer compliance guideline information to be entered and/or maintained in a database with a proprietary category classification tag assigned. The proprietary tags may be applied for buyers who have designated their compliance guidelines as business confidential and/or may require seller credentialing or preauthorization for access to the compliance guidelines.

In certain embodiments, the collaborative payment application 240 is adapted to utilize a unique buyer identification tag that is added and associated with the respective buyer compliance guideline information. A unique buyer identification tag may be utilized to facilitate maintenance of parent-child relationships between buyers or to provide a short code identifier to facilitate database queries, for example.

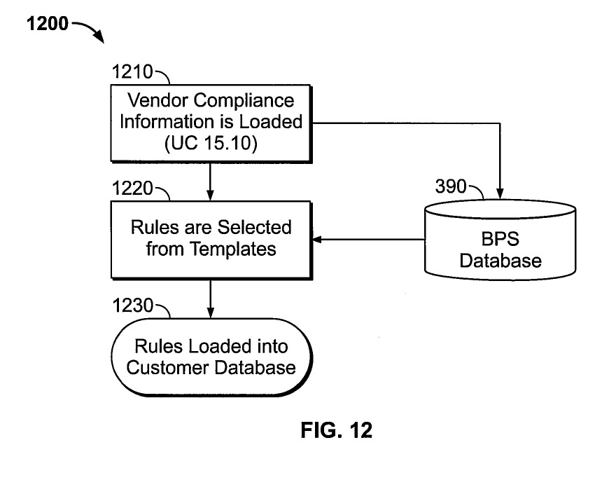

FIG. 12 illustrates a flow chart 1200 of the generation of business rules by the collaborative payment application 240 according to an embodiment of the present invention. More particularly, the flow chart 1200 illustrates generation of business rules from buyer compliance guideline information. The business rules may include cash application and adjustment management rules, for example. The rules may be used to determine whether to approve and write off invoice payment deductions or to deny and attempt to collect. For example, a percentage threshold or a dollar threshold may be employed. Additionally, the thresholds may vary based on the buyer. Business rules may also include captured deduction fee elements such as minimum charges per receipt, administrative fees per receipt, additional fees per designated unit, additional fees as a percentage of freight or transportation costs, additional fees as a percentage of the cost of merchandise, premium amounts for repeat violates, and/or other miscellaneous charges. Business rules may also be employed to determine deduction approval routing requirements and approval authorization levels based on percentage thresholds.

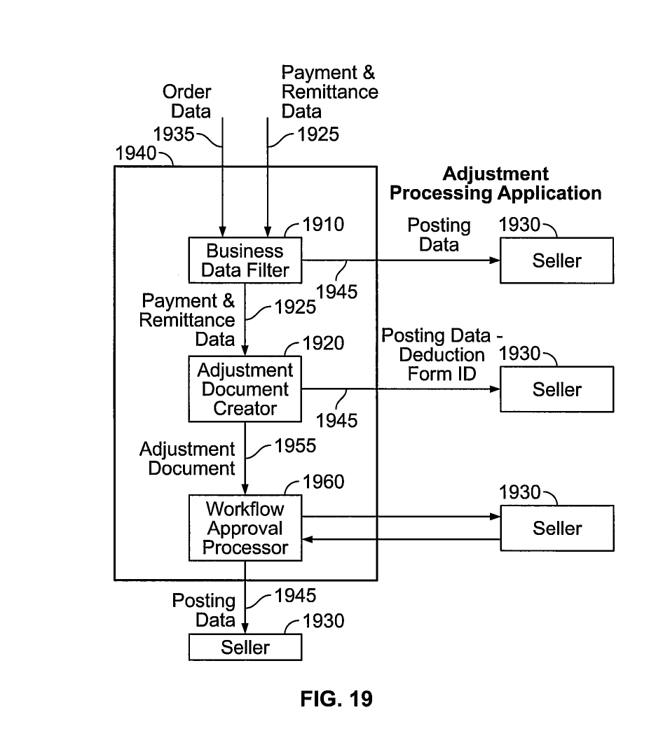

FIG. 19 illustrates an embodiment of an adjustment processing application 1940. As shown in FIG. 19, the adjustment processing application 1940 includes a business data filter 1910, an adjustment document creator 1920, and a workflow approval processor 1960. The deduction management application 1940 receives the payment and remittance data 1925 from the financial institution and the order data 1935 from the seller 1930. The payment and remittance data 1925 and order data 1935 are then passed to the business data filter 1910 of the adjustment processing application 1940.

In operation, the business data filter 1910 receives the order data 1935 and the payment and remittance data 1925 and attempts to match the payment and remittance data 1925 with one or more invoices included in the order data. If the business data filter 1910 is able to match the payment and remittance data 1925 with one or more invoices in the order data 1935, the business data filter sends posting data 1945 to the seller 1930 to close out the transaction. If the business data filter 1910 is not able to match the payment and remittance data 1925 with one or more invoices in the order data 1935, then the payment and remittance data 1925 is further processed by the business data filter.

The business data filter 1910 then applies a series of business rules in order to attempt to match the order data 1935 and the payment and remittance data 1925. If the business data filter 1910 is able to find a match after the application of the business rules, then the business data filter 1910 sends posting data 1945 to the seller 1930. The business rules applied by the business data filter may preferably be configured to be buyer specific.

However, if the business data filter 1910 is still not able to match the payment data to one or more invoices after the application of the buyer-specific business rules, the business data filter 1910 sends the payment and remittance data 1925 to the adjustment document creator. An adjustment document 1955 is then created at the adjustment document creator 1920. Posting data 1945 is also sent to the seller 1930 by the adjustment document creator 1920 to alert the seller's accounting system that a payment has been made and an adjustment document has been created.

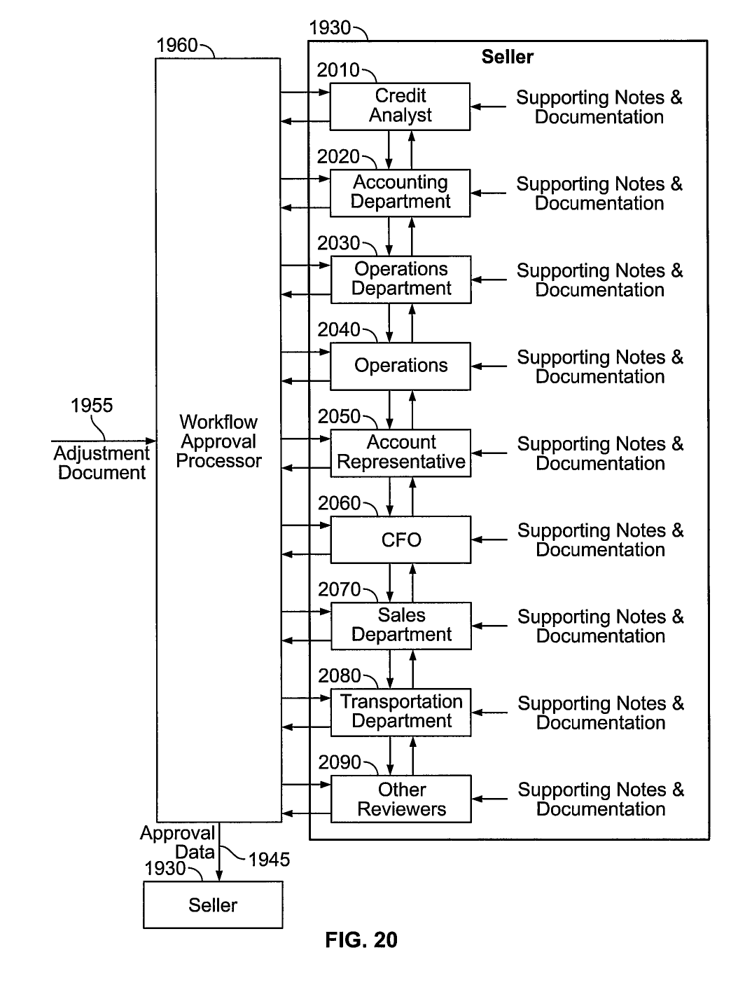

The assembled adjustment document 1955 is sent to the workflow approval processor 1960. The workflow approval processor 1960 routes the adjustment document 1955 to a predetermined and customizable set of human reviewers at the seller 1930 for review and/or approval. The routing of adjustment approval forms are further described below with regard to FIG. 20. If the adjustment document is approved by the set of human reviewers, then the workflow approval processor sends the additional posting data to the seller 1930. However, if the adjustment document is not approved by the set of human reviewers, the seller 1930 may instead forward the adjustment document to collections for further action.

The adjustment document 1955 preferably includes the payment data as well as all relevant data with regard to the buyer. The relevant data with regard to the buyer preferably includes the buyer's previous purchasing and payment activity including any credit rating, as well as seller-side information with regard to the buyer such as the seller's account representative for the buyer or any previous discounts given to the buyer.

The business data filter 1910 may also seek to validate payment data when the buyer's information is missing from the transaction. For example, if the payment data does not include an indication of the buyer, the business data filer 1910 may attempt to match the payment amount or any other available information to all outstanding invoices for all buyers. If a match is discovered, the business data filter 1910 may automatically prompt the user to confirm the attempted match from secondary criteria, for example, non-invoice identification fields.

Preferably, the transaction verification provided by the business rules includes the validation of the following aspects of the transaction. Validation of the customer information of the buyer. Validation of the delivery information of the goods transferred to the buyer, preferably including, for example, the invoice and/or bill of lading, and the dollar amounts. Validation of the buyer's payment such as determining whether the buyer's payment is a duplicate of an already received payment or if the amount remitted by buyer differs from the invoiced amount by a sum less than a predetermined threshold tolerance, or if the total invoice amount is less then a predetermined amount.

FIG. 20 illustrates an exemplary operation of the workflow approval processor 1960 in accordance with a pre-configured, buyer-specific adjustment approval workflow. In FIG. 20, the adjustment document 1955 is received by the workflow approval processor 1960. A pre-configured buyer-specific adjustment approval workflow is also preferably received by the workflow approval processor 1960 with the adjustment document 1955. The workflow approval processor 1960 may then route the adjustment document 1955 to one or more of the set of available human reviewers 2010-2080 in accordance with the pre-configured buyer-specific adjustment approval workflow. That is, the workflow approval processor 1960 preferably automatically routes the adjustment document to the seller's departments 2010-2080 for review. Additionally, each of the seller's departments 2010-2080 preferably has access to all of the supporting notes and documentation that may be incorporated into the adjustment document.

If no pre-configured buyer-specific adjustment approval workflow is received by the workflow approval processor 1960, the workflow approval processor 1960 may route the adjustment document to a default set of one or more of the reviewers 2010-2080. Additionally, if more than one human reviewer is viewing the adjustment document at the same time, a procedure to resolve any conflict may be implemented. Alternatively, the workflow rules may behave similarly to the business rules. That is, a default workflow may be implemented that is followed unless overridden by situation-specific rules. Buyer-specific situation-specific rules may be one example of situation-specific rules.

In the example of FIG. 20, the available reviewers include a credit analyst 2010, the accounting department 2020, the operations department 2030, one or more specific operations persons 2040, an account representative 2050, the Chief Financial Officer (CFO) of the seller 2060, the sales department 2070, and the transportation department 2080. Additional reviewers, as well as an automated analysis engine may also be added and the reviewers 2010-2080 of FIG. 20 are exemplary.

Additionally, although each reviewer is shown as directly communicating only with those reviewers close to it in the figure, in operation, each reviewer may preferably communicate with any other reviewer. For example, the account representative 2050 may send the adjustment document 1955 to the CFO 2060. In addition, the CFO 2060 may send the adjustment document 1955 to the accounting department 2020.

The reviewers may each send an individual approval or denial of the adjustment document 1955 to the workflow approval processor 1960. After receiving the individual approval or denial from each reviewer, the workflow approval processor 1960 sends approval data 1945 to the seller 1930. Alternatively, not all reviewers may have authority to approve an adjustment. For example, a specific reviewer may only be included in the workflow in order to attach a specific document or include some specific data in the adjustment document 1955. Because the posting data has already been sent to the seller's accounting system, the reviewer's approvals grant permission to have a credit issued for an already disputed item included in the adjustment document.

The workflow approval processor 1960 determines which reviewers should review the adjustment document 1955 and preferably automatically flows the adjustment document to the reviewer(s). This determination is made based on the buyer-specific workflow criteria customizable by the seller 1930. Once the adjustment document is received, the accompanying customizable criteria is preferably stored electronically within the workflow approval processor 1960 and associated with the adjustment document.

The workflow approval processor then routes the adjustment document based on the buyer-specific workflow. For example, a simple buyer-specific workflow may indicate that the adjustment document be sent to a credit analyst 2010 and then the CFO 2060. Consequently, the adjustment document may be transmitted to the credit analyst 2010. When the credit analyst 2010 approves the adjustment, the credit analyst's approval is then transmitted back to the workflow approval processor 1960. The workflow approval processor 1960 receives the approval and then examines the buyer-specific workflow to determine if any further approvals are necessary. In addition to a buyer-specific workflow, the workflow may be determined by a combination of buyer-specific and reason codes for the adjustment.

If an additional approval is necessary, the adjustment document is then routed to the next human for approval. In this case, the CFO's approval is also necessary, so the adjustment document is routed to the CFO.

Conversely, if the credit analyst 2010 does not approve of the adjustment, the disapproval is received by the workflow approval processor 1960 and the workflow approval processor 1960 then routes the adjustment document to collections for further action.

If no further approvals are necessary, then all humans in the buyer-specific workflow have approved the adjustment document and the buyer's payment, including the adjustment, is approved.

Alternatively, the buyer-specific workflow may include an analysis of the adjustment document beyond simply the buyer associated with the adjustment document. That is, the seller may configure the workflow approval processor to take additional data from the adjustment document into account when determining the routing for the adjustment document. For example, the workflow approval processor may be configured that for a single buyer, an adjustment below a certain threshold, for example, $10,000, may be referred to the credit analyst 2010. An adjustment above the threshold may be referred directly to the CFO.

Alternatively, the workflow approval processor may implement a global threshold for all buyers so that all adjustments for all buyers above the global threshold are automatically routed to a different set of human reviewers. For example, all adjustments greater than $100,000 may be immediately routed to the Sales Manager.

In addition to routing the adjustment document based on the amount of the adjustment, the workflow approval processor 1960 may have customizable criteria which examines any of the salesman information, order number, invoice total, deduction amount, total percentage amount, Inventory Records Affected indicator, and/or Reason for Non-Compliance Indicator of the customer compliance form example of an adjustment document 1955, for example, to assist in routing the adjustment document.

The workflow approval processor 1960 may also send the adjustment document 1955 to additional reviewers determined by comparison of the customizable criteria and the information in the adjustment document. For example, the customizable criteria of the workflow approval processor 1960 may also examine the total percentage amount of the customer compliance form example. The customizable criteria may require that the adjustment document 1955 be sent to the CFO 2060 if the total percentage amount of the adjustment document 1955 is greater than a given amount, such as, for example, 20%. When the criteria of the workflow approval processor 1960 is compared to the customer compliance form, the criteria may determine that the total percentage amount is less than 20%. Therefore, the workflow approval processor 1960 may not send the adjustment document 1955 to the CFO 2060. However, note that not all adjustment documents may have a percentage because not all documents reference a specific invoice.

After the workflow approval processor 1960 determines which reviewers should review the adjustment document 1955, the workflow approval processor 1960 sends the adjustment document 1955 to each of the selected reviewers. For example, the workflow approval processor 1960 may determine that the credit analyst 2010, operations department 2030, CFO 2060 and sales department 2080 should review the adjustment document 1955, but that the accounting department 2020, operations reviewer 2040, account representative 2050, and transportation department 2080 should not review the adjustment document 1955. In this case, the workflow approval processor 1960 would send adjustment document 1955 only to the credit analyst 2010, operations department 2030, CFO 2060 and sales department 2080.

Alternatively, a seller may have a problem with multiple people reviewing and trying to save different information to the same adjustment document. For example, it may be the case that the original reason behind the adjustment is no longer valid. The adjustment document may then need to be reclassified and then it may need to be sent to a whole new group of reviewers. Consequently, the flow process may route the adjustment document so that only one reviewer at a time gets the needed information and then routes the adjustment document to the next reviewer.

Once each reviewer receives the adjustment document 1955, the reviewer reviews the information contained within the adjustment document 1955. Each reviewer then approves, denies, or routes for further review the adjustment document 1955. The reviewer's approval or denial of the adjustment document 1955 is based largely on each reviewer's individual criteria. For example, if the credit analyst 2010 determines that, based on its criteria, that the adjustment document 1955 does not meet the credit analyst's 2010 criteria, then the credit analyst 2010 may deny the adjustment document 1955. Conversely, if the adjustment document 1955 does meet the criteria of the credit analyst 2010, then the credit analyst 2010 may approve the adjustment document 1955.

Each reviewer who receives the adjustment document 1955 reviews the adjustment document 1955 and either approves, partially approves, denies, or routes to additional reviewers. Each reviewer then sends approval or denial of the adjustment document 1955 to the workflow approval processor 1960. Alternatively, the adjustment document 1955 may be directly sent to the next reviewer upon evaluation by the first reviewer. Alternatively, a reviewer may interrupt the scheduled flow of the adjustment document to immediately direct the adjustment document to a certain new reviewer specific by the current reviewer. For example, an account representative may be reviewing the adjustment document and the adjustment document may be scheduled to pass to the sales department once the account representative's review is complete. However, the account representative may decide to countermand the usual procedure and bring the adjustment document immediately to the attention of the CFO, for example.

In one embodiment, if any reviewer denies the adjustment, the workflow processor refers the adjustment document to collections for further processing. If all reviewers approve the adjustment, then the adjustment is applied to the buyer's payment and the buyer's adjustment is approved and a credit memo is sent. That is, preferably, any amount sent by the buyer is posted immediately. If an adjustment or deduction is later approved, then a credit memo is sent to the seller's system to offset the payment shortfall. If the deduction is denied, then the shortfall remains on the account in aging and the matter is referred to collections.

In another embodiment, the adjustment document may be routed to one or more reviewers regardless of whether previous reviewers have approved or denied the adjustment. For example, an adjustment document may be denied by a first reviewer and yet still routed to a second reviewer. The second reviewer may then confirm or reverse the denial of the adjustment document. For example, if the credit analyst 2010, account representative 2050, and sales department 2070 all receive the adjustment document 1955 for their review, and the credit analyst 2010 and sales department 2070 both approve the adjustment document 1955, but the account representative 2050 denies the adjustment document 1955, the workflow approval processor 1960 may deny the adjustment document 1955.

If the workflow approval processor 1960 determines that the adjustment document 1955 should be approved, the workflow approval processor 1960 may then determine whether the adjustment document 1955 is requesting a deduction in the invoice amount or a refund for an overpayment. If the workflow approval processor 1960 determines that the adjustment document 1955 is requesting a refund for an overpayment, then the workflow approval processor 1960 may create posting data 1945. The posting data 1945 may contain directions to create an invoice in the amount of the overpayment.

However, if the workflow approval processor 1960 determines that the adjustment document 1955 is requesting a deduction in the invoice amount, then the workflow approval processor 1960 may include a credit memo in the amount by which buyer's invoice amount should be deducted (it is already deducted, that is how a 1955 document gets created. Also, it will not always reference a specific invoice number).

Conversely, if the workflow approval processor 1960 determines that the adjustment document 1955 should be denied, the workflow approval processor 1960 may refer the adjustment document to the seller's collections department to start the collection process. The collection process is the process of collecting past due monies on an outstanding bill. In this way, the workflow approval processor may begin efforts to collect the amount the buyer has yet to pay the seller 1930 for the seller's 1930 goods or collect the unauthorized deduction.

Alternatively, a reviewer in the workflow approval process may also approve or deny the adjustment document 1955 based on customizable tolerances. For example, in the first embodiment, a denial of the adjustment document 1955 by a single reviewer may result in the workflow approval processor 1960 denying the adjustment document 1955. However, in the alternative embodiment, the workflow approval processor 1960 may be customized to allow for a greater tolerance of one or several reviewer denials of the adjustment document 1955. In this way, the workflow approval processor 1960 may be customized to deny the adjustment document 1955 only when at least a majority of the reviewers denied the adjustment document 1955. Alternatively, the workflow approval processor 1960 may be customized to deny the adjustment document 1955 only when a ratio of reviewer denials to reviewer approvals is greater than a given amount.

Alternatively, any person included as part of the workflow may be allowed to deny the adjustment document at any point. However, there may preferably be only one final approver. Such a system may prevent reviewers from approving everything just so they don't have to spend time collecting if the adjustment is denied.

Returning now to the discussion of FIG. 12, the rules may be used as a template for sellers. Thus, participating sellers may choose whether to implement the generated rules. A template may provide ideas for cash application rules and preferable ways to route information, for example. The template may allow for implementing the vendor compliance guidelines from buyers.

When new buyer compliance guideline information is received, a system administrator may evaluate the rules and choose to deploy rule-set templates for cash application and adjustment management processing. The information may be inserted into the database 390 and sellers notified of the new templates. In certain embodiments, the rule-sets may be used for comparison of payment to invoices.

Typically, before the operation illustrated in the flow chart 1200 occurs, the database 390 is populated with data. For example, the database 390 may include data for sellers 230 who have signed up for the collaborative payment processing service provided by the collaborative payment system 200. In addition, typically a buyer 210 will have supplied buyer compliance guideline information.

After the operation illustrated in the flow chart 1200, which is described in more detail below, occurs, typically the generated business rules have been employed for adjustment management by a cash application.

At block 1210, buyer compliance guideline data is loaded. The loading of buyer compliance guideline data is described above in the flow chart 1100 illustrated in FIG. 11.

At block 1220, rules are selected from templates. The rules may represent preferred methods for data categorization (e.g., adjustment codes), cash application rules (e.g., automatically write off deductions under $50), and adjustment processing (e.g., ways to resolve certain adjustment issues).

At block 1230, the rules are loaded into a seller's cash application and adjustment management system.

In certain embodiments, the collaborative payment application 240 includes business rules for each buyer compliance guideline information rule that have been created by a third party. The third party may be the entity hosting the collaborative payment application 240, for example.

In certain embodiments, the collaborative payment application 240 is used in concert with an automated cash application solution such as the systems described in U.S. patent application Ser. No. 10/866,015 filed Jun. 10, 2004, entitled “System and Method for Automated Incoming Payment and Invoice Reconciliation.” The rule template may be directly imported by the cash application system. Seller A 230 may also learn of other systems or processes that are captured by the collaborative payment application 240 such as Adjustment Type categories (e.g., pricing, quantity, shipping, tax, warranty, marketing, etc.) or approaches to routing these issues around the seller's company via workflow. In the latter case, these work flow may also be imported directly into an automated adjustment processing system such as the one described in U.S. patent application Ser. No. 10/865,997 filed Jun. 10, 2004, entitled “System and Method for Seller-Assisted Automated Payment Processing and Exception Management.”

In certain embodiments, the collaborative payment application 240 is adapted to calculate the amount of deductions from buyer payments to sellers using parameters entered and/or maintained in a cash application or adjustment management system.

In certain embodiments, the collaborative payment application 240 is adapted to track changes made to all records. The changes may be tracked using, for example, user and/or date/time stamp information.

FIG. 13 illustrates a collaborative payment application 1300 according to an embodiment of the present invention. The collaborative payment application 1300 may be similar to the collaborative payment application 240, discussed above, for example. The collaborative payment application 1300 includes a user interface 1301, a loading seller information processor 1303, a comparing seller information processor 1304, a maintenance of seller information processor 1305, a notification of sellers of updated buyer information processor 1306, a maintenance of financial institution capabilities processor 1307, a notification of sellers of financial institution capabilities processor 1308, a notification of buyer of financial institution capabilities processor 1309, an optimization of processing processor 1310, a loading of buyer compliance guidelines information processor 1311, a generation of business rules processor 1312, and a database 1390.

The loading seller information processor 1303, the comparing seller information processor 1304, the maintenance of seller information processor 1305, the notification of sellers of updated buyer information processor 1306, the maintenance of financial institution capabilities processor 1307, the notification of sellers of financial institution capabilities processor 1308, the notification of buyer of financial institution capabilities processor 1309, the optimization of processing processor 1310, the loading of buyer compliance guidelines information processor 1311, the generation of business rules processor 1312 are in communication with the user interface 1301 and the database 1390.

In operation, the collaborative payment application 1300, like the collaborative payment application 240 described above, provides to participating buyers 210, financial institution 220, and sellers 230 in a collaborative payment system (such as collaborative payment system 200) payment strategies representing the “best practices” for transactions involving the buyers 210, the financial institution 220, and the sellers 230. Thus, buyers 210 and sellers 230 in a collaborative payment system each receive the benefit of the best practices for dealing with a particular buyer 210 or seller 230. The collaborative payment application 1300 may also act as repository for buyer compliance guideline information. Thus, sellers 230 and the financial institution 220 have access to the compliance guidelines for each buyer 210 for use in processing transactions.

The user interface 1301 allows a system administrator to interact with the collaborative payment application 1300. In addition, the user interface 1301 allows the system administrator to provide information to and receive information from the collaborative payment application 1300 during the operation of the various processors discussed below. The user interface 1301 may be similar to the user interfaces discussed above.

The loading seller information processor 1303 is adapted to load seller information into the database 1309. The loading seller information processor 1303 may utilize a processing flow similar to that illustrated in flow chart 300 in FIG. 3, discussed above, for example.

The comparing seller information processor 1304 is adapted to compare seller information with data stored in the database 1390. The comparing seller information processor 1304 may utilize a processing flow similar to that illustrated in flow chart 400 in FIG. 4, discussed above, for example.

The maintenance of seller information processor 1305 is adapted to maintain seller information stored in the database 1390. The maintenance of seller information processor 1305 may utilize a processing flow similar to that illustrated in flow chart 500 in FIG. 5, discussed above, for example.

The notification of sellers of updated buyer information processor 1306 is adapted to notify sellers when buyer information is updated in the database 1390. The notification of sellers of updated buyer information processor 1306 may utilize a processing flow similar to that illustrated in flow chart 600 in FIG. 6, discussed above, for example.

The maintenance of financial institution capabilities processor 1307 is adapted to maintain financial institution capabilities in the database 1390. The maintenance of financial institution capabilities processor 1307 may utilize a processing flow similar to that illustrated in flow chart 700 in FIG. 7, discussed above, for example.

The notification of sellers of financial institution capabilities processor 1308 is adapted to notify sellers when financial institution capabilities are updated in the database 1390. The notification of sellers of financial institution capabilities processor 1308 may utilize a processing flow similar to that illustrated in flow chart 800 in FIG. 8, discussed above, for example.

The notification of buyer of financial institution capabilities processor 1309 is adapted to notify buyers when financial institution capabilities are updated in the database 1390. The notification of buyer of financial institution capabilities processor 1309 may utilize a processing flow similar to that illustrated in flow chart 900 in FIG. 9, discussed above, for example.

The optimization of processing processor 1310 is adapted to optimize the processing of transactions between buyers, sellers, and financial institutions based on data stored in the database 1390. The optimization of processing processor 1310 may utilize a processing flow similar to that illustrated in flow chart 1000 in FIG. 10, discussed above, for example.

The loading of buyer compliance guidelines information processor 1311 is adapted to load buyer compliance guidelines information into the database 1390. The loading of buyer compliance guidelines information processor 1311 may utilize a processing flow similar to that illustrated in flow chart 1100 in FIG. 11, discussed above, for example.

The generation of business rules processor 1312 is adapted to generate business rules based on data stored in the database 1390. The generation of business rules processor 1312 may utilize a processing flow similar to that illustrated in flow chart 1200 in FIG. 12, discussed above, for example.

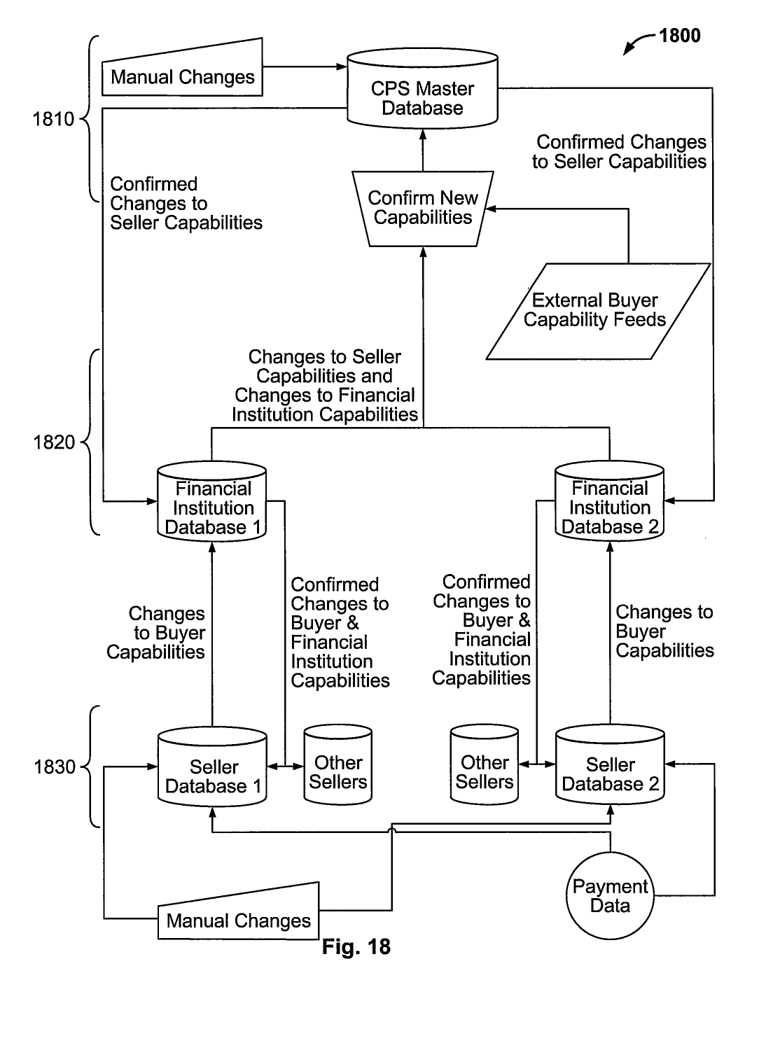

FIG. 18 illustrates a collaborative payment system 1800 in which the collaborative payment application is distributed hierarchically according to an embodiment of the present invention. The collaborative payment system 1800 may be similar to the collaborative payment system 200, described above, for example. The collaborative payment application of the collaborative payment system 1800 is distributed across three layers. The first layer includes the master application host 1810. The second layer includes the participating financial institutions 1820. The third layer includes the participating sellers 1830. The database of the collaborative payment system 1800 is distributed across these layers, which each layer including the data applicable to that layer. For example, Seller Database 1 includes data from the database 390 that is applicable to Seller 1, but may not include data relating to other sellers in the system 1800. Similarly, the Financial Institution Database 1 may include data relating to the Financial Institution 1 and sellers the Financial Institution 1 deals with, but not sellers that utilize a different financial institution. The master application host 1810 is in communication with the financial institutions 1820. The financial institutions 1820 are in communication with the sellers 1830. A particular financial institution may only be in communication with sellers that the financial institution deals with; that is, a subset of all participating sellers 1830.

Generally, in operation, the system 1800 behaves similarly to the collaborative payment system 200, described above. Changes flow “up” the hierarchy and are then propagated “down” the hierarchy after the changes have been confirmed. For example, when a seller makes a change to the seller's database (e.g., updating a buyer's capabilities), that change is propagated to the database of the financial institution that the seller deals with. The financial institution database then propagates the change to the master application host's database. Once the master application host confirms the change, the change is then propagated down the hierarchy to the other financial institutions. Those financial institutions in turn propagate the changes to their respective sellers.

Although the term “buyer” has been used throughout this application, it is recognized that an actual buyer may outsource some or all of their payment activities to a third party or have various activities hosted or provided by a third party. For example, the buyer may outsource document imaging. The term buyer is broadly drawn to include any entity submitting payment including distributors, purchasing groups, independent third parties, franchisees, transporters and other entities that are involved in the purchasing process.

Similarly, the term “seller” has also been used throughout, but may actually represent a third party or hosted application or other arrangement. Consequently, the term seller may be broadly drawn to include any entity receiving payment for goods or services.

Additionally, as discussed above, the embodiments of the present collaborative payment application 240 may be delivered in any of a variety of implementations. For example, the collaborative payment application 240 may be installed at a financial institution, hosted by the seller, outsourced to a third party provider, or installed at the seller.

Thus, certain embodiments of the present invention provide systems and methods for collaborative payment strategies. As part of a collaborative payment system, buyers, sellers, and financial institutions may utilize a collaborative payment application to facilitate collaboration and share best practices for processing payments and deductions. In certain embodiments, the collaborative payment system acts as repository for buyer compliance guideline information. The collaborative payment system facilitates transactions between buyers, sellers, and financial institutions using best practices derived from shared knowledge of each participant's capabilities and practices.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

1. A method for collaborative payment.
